(19) United States
(12) Patent Application Publication
(10) Pub. No.: US 2006/0155589 A1
(43) Pub. Date: Jul. 13, 2006

(54) Portable vital signs measurement instrument and method of use thereof

(75) Inventors: John A. Lane, Weedsport, NY (US); Michelle S. McGrath, Camillus, NY (US); Craig Michael Meyerson, Syracuse, NY (US); David G. Perkins, Tully, NY (US); Stephen C. Wilson, Camelot (SG); Robert J. Wood SR., Syracuse, NY (US)

Correspondence Address: WALL MARJAMA & BILINSKI, 101 SOUTH SALINA STREET, SUITE 400, SYRACUSE, NY, 13202, US

(73) Assignee: Welch Allyn, Inc., Skaneateles Falls, NY (US)

(21) Appl. No.: 11/032,625

(22) Filed: Jan. 10, 2005

(51) Int. Cl. G06Q 40/00

(52) U.S. Cl. 705/4

(57) ABSTRACT

The invention is a portable vital signs measurement instrument, systems and methods that provide a variety of measurement capabilities, including blood pressure, temperature, pulse oximetry, and other indications of patient status. The instrument, systems and methods include the ability to communicate wirelessly, for example using Wi-Fi (IEEE 802.11B), with a server, so that information can be entered easily, securely and reliably into a medical database system accessible by way of the server. The systems and methods provide for the instrument to initiate a communication session by attempting to discover a server access point in its vicinity.

### CROSS-REFERENCE TO RELATED APPLICATIONS

This application is related to co-pending U.S. patent application Ser. No. 10/619,380, filed Jul. 14, 2003, entitled “Motion Management in a Blood Pressure Measurement Device,” and subject to assignment to the common assignee of the present application, which application is incorporated herein by reference in its entirety. This application hereby incorporates herein by reference the entire disclosure of each of U.S. Pat. Nos. 6,544,173, 6,544,174, and 6,616,606, and the entire disclosure of each of co-pending U.S. patent application Ser. No. 10/643,487, filed Aug. 19, 2003 and entitled “Apparatus and Method of Digitally Archiving a Patient Encounter,” and co-pending U.S. patent application Ser. No. 10/806,770, filed Mar. 22, 2004 and entitled “Personal Status Physiological Monitor System and Architecture,” all of which patents and applications are subject to assignment to the common assignee of the present application.

### FIELD OF THE INVENTION

The invention relates to vital signs measurement apparatus in general and particularly to a vital signs measurement apparatus that can automatically connect to a data management system.

### BACKGROUND OF THE INVENTION

Instruments useful for measuring vital signs of patients are well known and have been used for many years. In general, there are a wide variety of instruments which require a significant amount of training and experience for effective use. Furthermore, recording the data obtained from such instruments frequently involves the manual writing of notes by a practitioner, which notes are later transcribed and entered into a computer-readable database. In some instances, a computer terminal is provided proximate to an area where patient vital signs measurements are made, and the measurements are sometimes recorded directly into a database by way of the terminal.

A number of problems in taking such vital signs measurements and in recording and disseminating the results have been observed. In some instances, the readings are made available only after some delay. In some instances, the necessity to locate and deal with a computer terminal is inconvenient for the practitioner or there can be errors introduced during the transcription process.

There is a need for a portable vital signs measurement instrument and system that provides for the automated, convenient, and ubiquitous availability of a readily used instrument that assists the practitioner in obtaining and recording patient information in an accurate and expeditious manner.

### SUMMARY OF THE INVENTION

Instruments embodying principles of the invention include a portable vital signs measurement device, designed to meet the needs of alternate care and general hospital use. In an exemplary embodiment, the instrument is intended to provide the physician, physician's assistant, or nurse, facing high patient traffic or multiple tasks, a cost effective method to determine a one-time vital signs reading. One exemplary embodiment that is described herein is referred to as “Spot Ultra.” In some embodiments, the instrument comprises an IEEE 802.11-compliant wireless connectivity module that is configured to automatically search for and make connection with a data management system configured to handle medical data by way of a corresponding transceiver connected to the data management system. The portable vital signs measurement device in one embodiment measures systolic and diastolic blood pressure, MAP, pulse rate, temperature (oral, adult axillary, pediatric axillary, rectal, and ear (using IR technology)), and oxygen saturation (SpO₂) of adult and pediatric patients. In some embodiments, the instrument comprises automated blood pressure (BP) measurement, such as described in co-pending U.S. patent application Ser. No. 10/619,380, which application has been incorporated herein by reference in its entirety. In some embodiments, the instrument optionally comprises a thermometry unit capable of measuring a patient temperature, such as the SureTemp Plus® oral, adult and pediatric axillary, and rectal thermometry with sealed removable probe well or the Braun Pro4000 tympanic thermometry (both available from Welch Allyn, Skaneateles Falls, N.Y.), pulse oximetry (SpO₂) instrumentation, instrumentation configured to measure cardiac parameters such as pulse rate, mean arterial pressure and an external printer. In some embodiments, the printer is an external 2″ thermal printer, optionally battery powered, with either cabled or wireless communication capability. The system comprises both hardware and software components, and is described in greater detail below. In some embodiments, the instrument comprises one or more of memory for recording the results of one or more vital signs measurements, and a 1-D linear imager bar code scanner accessory, which can be used for example for patient identification such as by reading a bar code printed on a bracelet worn by the patient.

Examples of the many venues and settings where portable vital signs measurement devices according to the invention can be used include, but are not limited to: hospitals, including medical and surgical wards, emergency departments, maternity facilities, obstetrics facilities, endoscopy facilities, and hyperbaric units; medical practices, including family and general practices, pediatric practice, internal medicine, osteopathic practice, and obstetrics and gynecology; long term care facilities; clinics associated with hospitals, HMOs and PPOs; ambulatory care clinics; dialysis centers; and prisons.

In one aspect, the invention relates to a portable vital signs measurement module. The portable vital signs measurement module comprises a portable measurement module configured to measure at least one vital sign of a patient, and to produce a signal representative of the at least one vital sign; and a wireless communication interface module configured to receive the signal representing the at least one vital sign and configured to communicate with a remote wireless communication device, the wireless communication interface module configured to initiate the communication with the remote wireless communications device using a first communication of the remote wireless communications device, and a second communication for transmitting data. The at least one vital sign of the patient can be monitored and the signal representing the at least one vital sign can be provided wirelessly to the remote wireless communication device. In one embodiment, the first communication is intended to discover the presence of the remote wireless communications device.

In one embodiment, the data is transmitted in a secure communication. In one embodiment, the portable vital signs measurement module further comprises a display. In one embodiment, the display comprises an LCD display. In one embodiment, the portable vital signs measurement module further comprises a printer. In one embodiment, the portable vital signs measurement module further comprises a microprocessor and a memory. In one embodiment, the portable vital signs measurement module further comprises a control configured to be operable by an operator of the portable vital signs measurement module. In one embodiment, the at least one vital sign is a selected one of a non-invasive blood pressure, a pulse rate, a temperature, a physiological level of a chemical substance, a respiration rate, and a waveform indicative of a vital sign. In one embodiment, the portable vital signs measurement module further comprises a transducer configured to measure the at least one vital sign. In one embodiment, the transducer configured to measure the at least one vital sign is demountably attached to the portable measurement module. In one embodiment, the portable vital signs measurement module further comprises a stand for supporting the portable vital signs measurement module.

In another aspect, the invention features a portable vital signs measurement system. The portable vital signs measurement system comprises a portable measurement module configured to measure at least one vital sign of a patient, and to produce a signal representative of the at least one vital sign; and a wireless communication interface module configured to receive the signal representing the at least one vital sign and configured to communicate with a remote wireless communication device, the wireless communication interface module configured to initiate the communication with the remote wireless communications device using a first communication intended to discover the presence of the remote wireless communications device, and a second communication for transmitting data; and the remote wireless communication device in communication with a computer-based data management system. The at least one vital sign of the patient can be monitored and provided to the computer-based data management system by way of the remote wireless communication device.

In one embodiment, the data is transmitted in a secure communication. In one embodiment, the portable vital signs measurement system further comprises a display. In one embodiment, the display comprises an LCD display. In one embodiment, the portable vital signs measurement system further comprises a printer. In one embodiment, the portable vital signs measurement system further comprises a microprocessor and a memory. In one embodiment, the portable vital signs measurement system further comprises a control configured to be operable by an operator of the portable vital signs measurement system. In one embodiment, the at least one vital sign is a selected one of a non-invasive blood pressure, a pulse rate, a temperature, a physiological level of a chemical substance, a respiration rate, and a waveform indicative of a vital sign. In one embodiment, the portable vital signs measurement system further comprises a transducer configured to measure the at least one vital sign. In one embodiment, the transducer configured to measure the at least one vital sign is demountably attached to the portable measurement system. In one embodiment, the portable vital signs measurement system further comprises a stand for supporting the portable vital signs measurement system.

In still another aspect, the invention relates to a method of measuring a vital sign of a patient. The method comprises the steps of providing a portable vital signs measurement module, measuring the at least one vital sign of the patient; and transmitting wirelessly the signal to the remote wireless communication device. The portable vital signs measurement module comprises a portable measurement module configured to measure at least one vital sign of a patient, and to produce a signal representative of the at least one vital sign; and a wireless communication interface module configured to receive the signal representing the at least one vital sign and configured to communicate with a remote wireless communication device.

In some embodiments, the method further comprises the step of communicating the signal representative of the at least one vital sign from the remote wireless communication device to a computer-based data management system in communication therewith.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIGS. 1A-1F are drawings in different views showing an embodiment of the portable vital signs measurement instrument according to the invention;

FIGS. 2A-2F are drawings in different views showing a second embodiment of the portable vital signs measurement instrument according to the invention;

FIG. 2G is a drawing showing an embodiment of the portable vital signs measurement instrument mounted on a stand, according to the invention;

FIG. 3 is a diagram that illustrates a preferred embodiment of the overall system architecture of the portable vital signs monitoring instrument, according to principles of the invention;

FIG. 4 illustrates an exemplary embodiments of an LCD display, according to principles of the invention;

FIG. 5A illustrates an exemplary embodiment of a keypad having a plurality of buttons therein, according to principles of the invention;

FIG. 5B is a diagram in tabular form illustrating the primary function for each button of the keypad of FIG. 5A, according to principles of the invention;

FIG. 6 is a diagram depicting the software architecture of a generic software module of an embodiment of the portable vital signs measurement instrument, according to principles of the invention;

FIG. 7 is a diagram that illustrates the interaction of the portable vital signs measurement instrument software, including system modules, with the hardware of the portable vital signs measurement instrument through external interfaces, according to principles of the invention;

FIG. 8 is a diagram that illustrates the interaction of the portable vital signs measurement instrument software, including service modules, with hardware components of the portable vital signs measurement instrument, according to principles of the invention;

FIG. 9 is a schematic diagram showing an embodiment of the flow of communications between a portable vital signs measurement instrument and a server, according to principles of the invention; and

FIG. 10 is a diagram showing an embodiment of a subscribe and publish process between a plurality of portable vital signs measurement instruments and a server, according to principles of the invention.

### DETAILED DESCRIPTION OF THE INVENTION

The invention provides a portable vital signs monitoring instrument that is convenient for a medical practitioner to operate, and that has the ability to interact by wireless methods with a database system in a medical practice or hospital environment to maintain patient records with the ability to provide secure access to the records according to requirements such as those of the Health Insurance Portability and Accountability Act of 1996 (hereinafter “HIPPA”). Under HIPPA, health care providers now must have the patient's written permission before they can release any of the patient's medical information to anyone else. A consequence of this requirement is that medical data management systems need to have provisions that prevent those lacking proper authorization from viewing the contents of a person's medical records, based on the default condition that authorization has not been given. In addition, the ability to record permissions and to identify potential viewers of information can permit the automation of determining whether and to what extent access to specific information is permitted by a given potential viewer under HIPPA. One can also understand the terms “secure access” or “secure communication” to connote a communication that is unintelligible to a device that is not part of the system or network in which the secure communication takes place. In this context, one can have secure communication by applying encryption to the information communicated, and/or by using technology such as spread spectrum communication methods to limit access to the communication channel itself. Various standard wireless communication systems presently in use provide secure communication channels based on encryption and/or spread spectrum methods. In addition to these secure communication methods, software can be used to provide the kind of privacy required by HIPPA, and to control and to determine what data to allow a particular user of the system to access or to view. In other embodiments, the communication can be performed by any of a wireless communication technology, a hardwired communication technology such as RS-232 or Ethernet, or by using a removable machine-readable and writeable medium such as a floppy disk or a semiconductor memory device, for example, a memory stick, a flash memory, or an SD memory module that can be transferred to another device for the purpose of transferring data, control signals, or programs.

HIPAA established standards for health care and health care information as part of the Social Security Act. In order to implement this Federal Law, the U.S. Department of Health and Human Services has created rules which are also known as the HIPAA Regulations (45 C.F.R. 160-164), which can be found in the Federal Register and on the web. The guiding concepts are that medical information stored in databases should be accurate and secure and access to such information should be restricted to those who legitimately need the information and are approved to receive the information, for example by a consent or authorization signed by the person to whom the information pertains, or by an individual legally entitled to act on behalf of the person to whom the information pertains. The regulations apply to health plans, health care clearinghouses and health care providers, collectively called Covered Entities (or “CE”), who transmit information covered by HIPPA (known as “Protected Health Information”) in electronic form.

In the present invention, a process is implemented in which compliance with HIPAA is achieved by the use of a reader of a machine-readable repository of information, such as a barcode scanner, a radio frequency identifier tag (or “RFID tag”) reader, a magnetic record reader such as a magnetic stripe reader, or a reader of a memory such as a semiconductor memory in a flash card, SD card, PCMCIA card or other semiconductor memory format, and one or more software modules configured to interpret information encoded in the machine-readable repository of information and to respond to such information, including responses involving logic and control functions. The apparatus of the invention in some embodiments includes such a reader configured to read the machine-readable repository of information. In some technologies, the apparatus of the invention can additionally write to the machine-readable repository of information. The machine-readable repository of information can be used to identify a selected one of a patient and a clinician in a manner accessible to electronic equipment such as the portable vital signs measurement instrument. In one embodiment, the instrument comprises an optical, electronic, or magnetic reading device, which is used to transfer to the instrument sufficient information, such as an ID number or alphanumeric string that uniquely identifies the person presenting a barcode, an RFID tag or other machine-readable repository of information. The instrument can, for example, communicate with a local or remote database to determine the status of the identified individual (e.g., a patient, a clinician with authority to view some or all of the patient's records, a clinician who is authorized to enter information but not retrieve or view information not entered by that clinician, or a family member or volunteer, such as a “candy-striper,” who has no authority to view any information about the patient). In response to the identification of the person involved, the instrument can be programmed to accept, record, transfer, request and/or display information in accordance with the authority of the person identified. In some instances, if a non-authorized person is present, the instrument may be programmed to inhibit some functions, for example, providing audible responses that might be overheard, or limiting access to information unless an authorized person enters a personal identifier directly, such as a personal identification number or string, so that an unauthorized person cannot seruptitiosly gain access to information when a caregiver comes into proximity with the instrument, for example to deal with another patient in the next bed. Using the authorization, the instrument, when properly activated, can link, or embed together, the patient information and the clinician's identification to manage access control, personal authentication, data integrity, audit control, transmission security, and any other function requiring authorization.

In some instances, a health care facility or hospital may elect to deactivate this feature and possibly not use a barcode system or other machine-readable system with the instrument. By way of example, in an emergency room (“ER”), where every second counts, it may be more convenient to have a manual system and a restricted access policy and system that prevents any non authorized personnel from entering the ER patient areas in which is present equipment which could likely meet the HIPAA standards. In other embodiments, in systems wherein the use of barcode or other machine-readable identification is used, the patient record is combined with and has embedded therein the clinician identification. As an example, the clinician information can be a designated identifier format, and/or information entered in a specified field in a record, such as a prefix or suffix attached to each entry or scan of the patient ID. By way of example, a clinician might identify him- or herself and take a vital sign reading according to the sequence that follows:

The clinician scans in his/her ID;

The clinician scans in the patient ID, for example as a bar code on a wrist bracelet;

The clinician is cleared to take vital signs such as blood pressure, temperature, etc. and does so;

The clinician is or is not cleared to edit, retrieve, or print data based on preprogrammed hospital policy;

If the clinician is cleared and prints the data, the clinician ID code is embedded within the printed patient barcode or record so one can determine who retieved the controlled information.

In one embodiment, the patient barcode is programmed to contain the clinician prefix or suffix, for example.

In some embodiments, the system can be programmed to warn (by printing, by enunciating, by visual display or by any other convenient procedure) cleared individuals, such as a doctor or nurse, that any information printed or saved/transferred externally is subject to HIPAA rules. The system can be programmed to notify clinical management if un-authorized access is being requested, for example a drug sales representative attempting to identify patients who might require a medication sold by the representative.

In some embodiments, another feature of the inventive instrument is a location module that provides the ability to discover a location (such as a floor, or a room on a particular floor) of a particular instrument. In some embodiments, a history tracking module is provided to track the history of usage of a particular instrument, either by reviewing the information transmitted by the instrument, or by querying the instrument to provide a log of is activity. For example, one can locate a specific instrument unit (for example by serial number) through analysis of the instrument's access point connections, its signal strength, performing location identification data manipulation such as triangulation, and by examining the instrument's interaction with tags of known location (for example, RFID tags or transponders in specific rooms) so that a given instrument can be identified as being situated in a specific hospital unit or ward.

By way of example, the Ekahau Positioning Engine™ 3.0, available from Ekahau, Inc., 620 Herndon Parkway, Suite 200, Herndon, Va. 20170, is a software based solution that enables location tracking via any standard WiFi network compatible with 802.11a/b/g. The instrument in some embodiments comprises a WiFi transceiver that can be used to track device. In various operational modes, a system can be programmed to periodically scan every location to identify the location of instruments. If the system has trouble tracking an instrument, the system can issue a command to have the instrument identify its location and transmit the same. In some embodiment, the location feature can be used to find “missing” units. In some embodiments, the system can monitor which devices have been used, how often, and where such use has occurred. Such information can be used to determine current workload and usage for particular locations, and can be used to optimize the allocation of instruments.

In one embodiment, the system can track usage to see if a unit has not been used for a long time or is one that is being overused. In some instances, this information can help to determine if devices are working correctly or may be damaged or need maintenance or repair. For example, an instrument that is shunned by workers may indicate that there is some undiagnosed problem, for example an old battery that won't hold a charge. In other instances, it is possible to track users to specific devices. This information can be used to debug particular problems on a device, because one can then track who was using an instrument and when, and the user can be asked about the performance of the instrument. The system can also be used to track instruments for keeping inventory, and to prevent theft or misappropriation of expensive equipment. For example, if and when an instrument leaves a particular zone, one or more alarms situated in either or both the system, an entryway, or on the instrument itself may sound. In addition, the instrument can be programmed to “lock up” or disable one or more subsystems to prevent anyone from using it.

In yet another circumstance, it is possible to communicate with individual health care providers by tracking the user of a specific instrument (whether or not a precise location is known), one can send messages to the specific instrument where the known user is logged in. This is a way to get message to individuals, for example RN's on the floor, without using a pager, a cellular telephone, or a similar personal remote communication device.

Still another feature of the instrument, in some embodiments, can include the ability of the instrument to participate in communication networks. In one embodiment, the instrument supports a Personal Area Network (PAN). The PAN comprises wireless sensors and associated electronics that have limited transmission distances and are coded to communicate to a particular base unit only. The base unit in one embodiment is the instrument. In use, the sensors could include SpO₂, ECG, blood pressure, temperature, body mass, weight, or any other medical instrument that collects or monitors data from any sensor. The network is set up around the patient such that all the devices are secure and the information is controlled from one access point, the instrument.

The PAN can implement improved patient monitoring without the use of leads and thus can maintain a higher level of electrical isolation. The PAN also extends the level of mobility that the patient has while still being monitored and makes the operation of the system simpler and automatic. The application of the PAN does not prevent the monitor from also acting like a Hub, which is described next.

The Hub is a central access point through which data is communicated. A hub is connected to a LAN (Local Area Network) via a hard-wired connection or with wireless technology. In some embodiments, the instrument of the invention comprises a Hub. The Hub provides for the communication of data by an authorized person and control of some or all of the instruments or measurement devices that are connected via the Hub. i.e., inquiries can be made remotely, and data can be managed from a central location. Devices that are not necessarily associated with the vital signs monitoring instrument can be connected and operated by the system via this hub. This may include items such as printers, fax machines, other medical devices and other computers. AS will be appreciated, the operation of the instrument as a Hub does not preclude it from also acting a PAN.

In one embodiment, the portable vital signs monitoring instrument is useful to take blood pressure on pediatric and adults patients of any gender from ages 29 days and older. The portable vital signs monitoring instrument's SpO₂ and Temperature modules are qualified to be used on neonates.

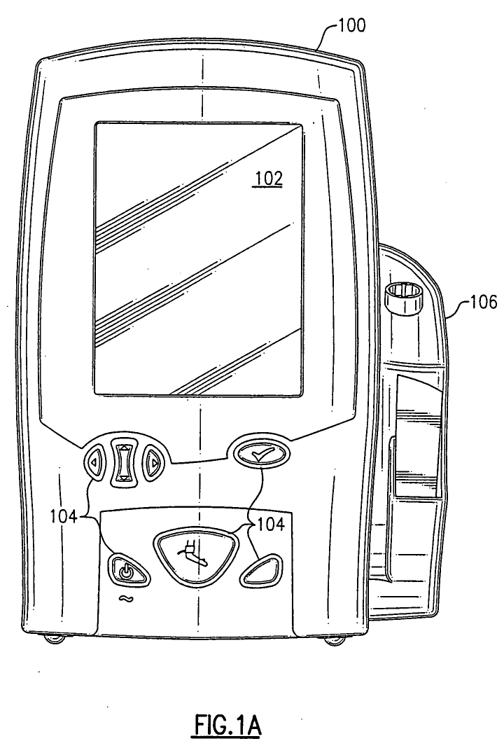

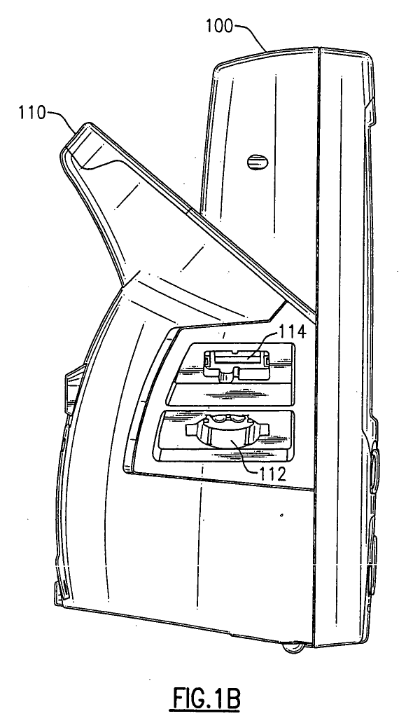

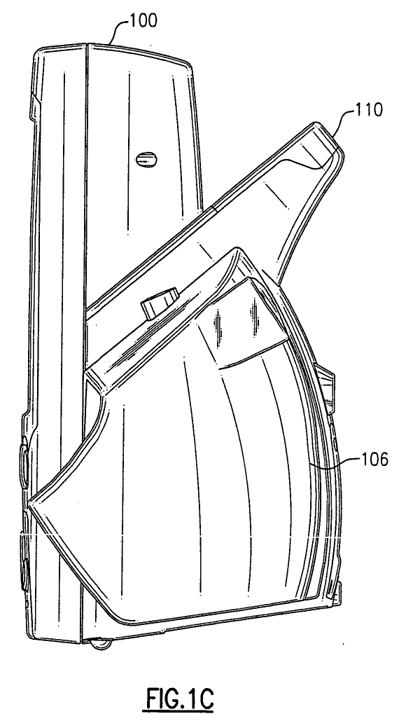

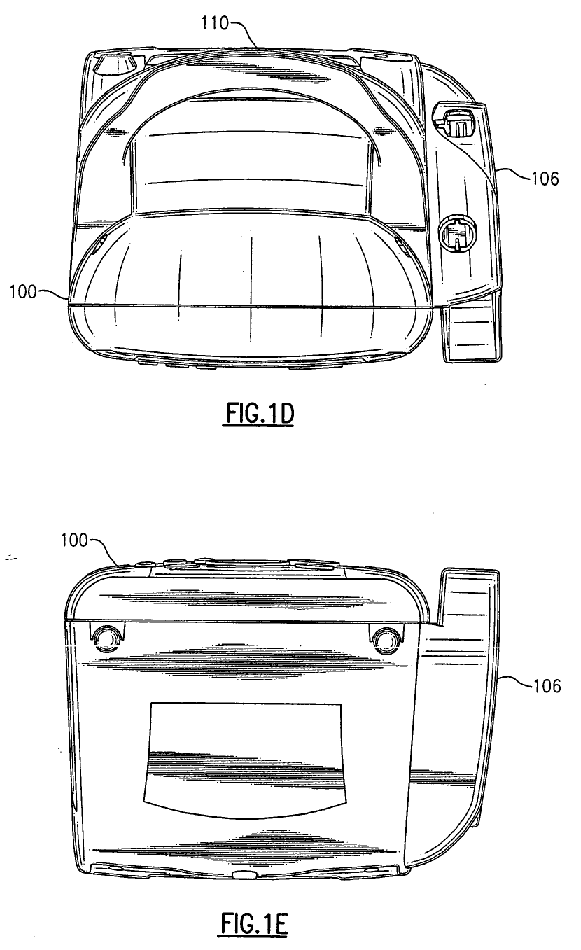

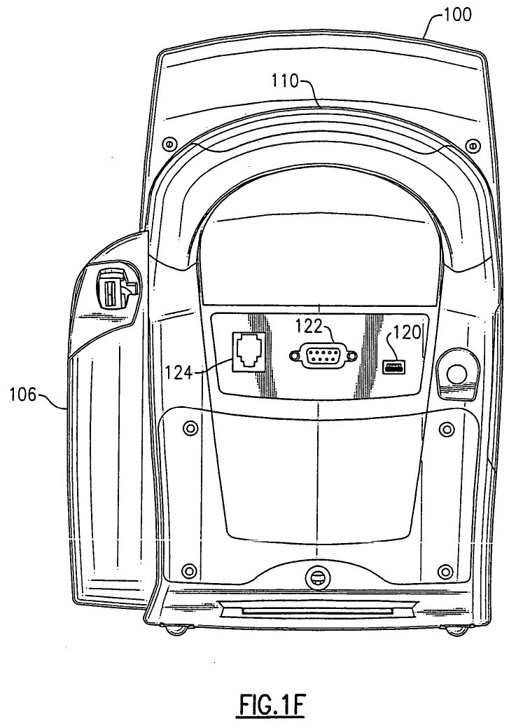

FIGS. 1A-1F are drawings in different views showing an embodiment of the portable vital signs measurement instrument. FIG. 1A is a front elevation view of a portable vital signs monitoring instrument 100 showing a display 102 and a plurality of keys 104, as well as a well 106 for holding a thermometer instrument. FIG. 1B is a side elevation view of the portable vital signs monitoring instrument 100 showing the left side thereof relative to the view of FIG. 1A. In FIG. 1B there is shown a handle 110 for lifting, carrying, or pulling the portable vital signs monitoring instrument 100. Also shown in FIG. 1B is a connector 112 for a blood pressure cuff, and a connector 114 for a pulse oximetry connection. FIG. 1C is a side elevation view of the portable vital signs monitoring instrument 100 showing the right side thereof relative to the view of FIG. 1A. The handle 110 is visible in FIG. 1C, as is the side of the well 106 for holding a thermometer. FIG. 1D is a top view of portable vital signs monitoring instrument 100, in which the handle 110 and the thermometer well 106 are visible. FIG. 1E is a bottom view of the portable vital signs monitoring instrument 100, in which the thermometer well 106 is visible. FIG. 1F is a rear elevation view of the portable vital signs monitoring instrument 100. In FIG. 1F there is visible the handle 110, and the thermometer well 106, as well as three connectors; connector 120 provides connection to a personal computer such as a USB port, connectors 122 and 124 are 9 wire serial connectors, for example for an RS232 port. However, in other embodiments, different types of connectors can be used as one or both of connectors 122 and 124, such as an Ethernet, USB, or TTL Port.

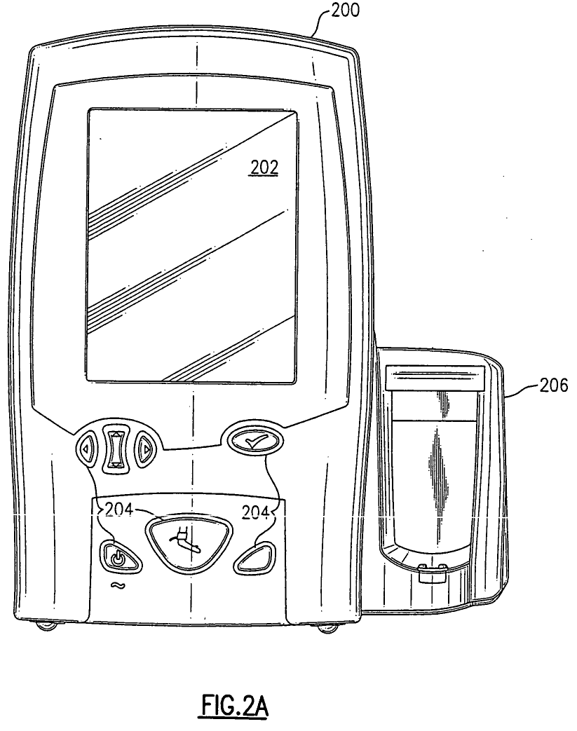

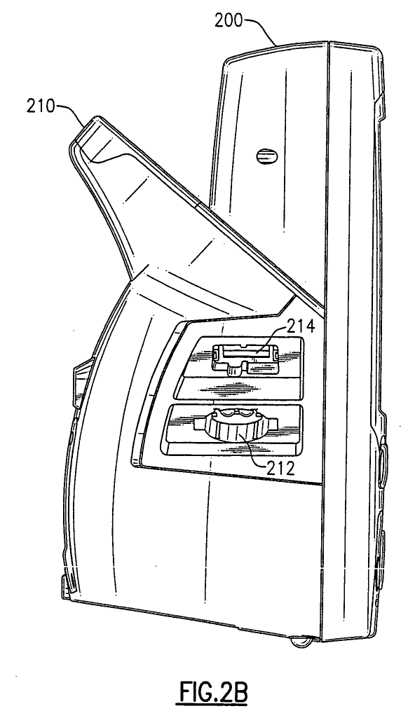

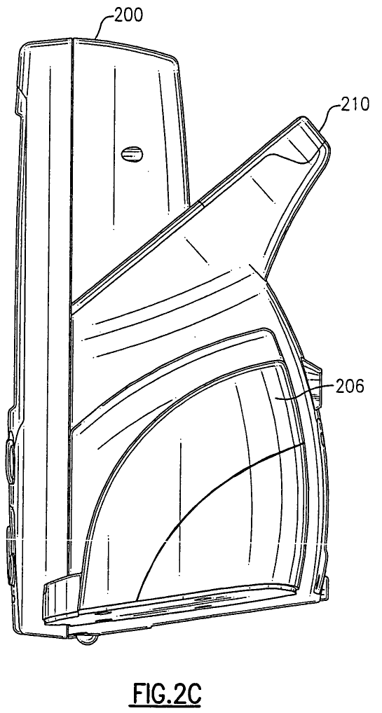

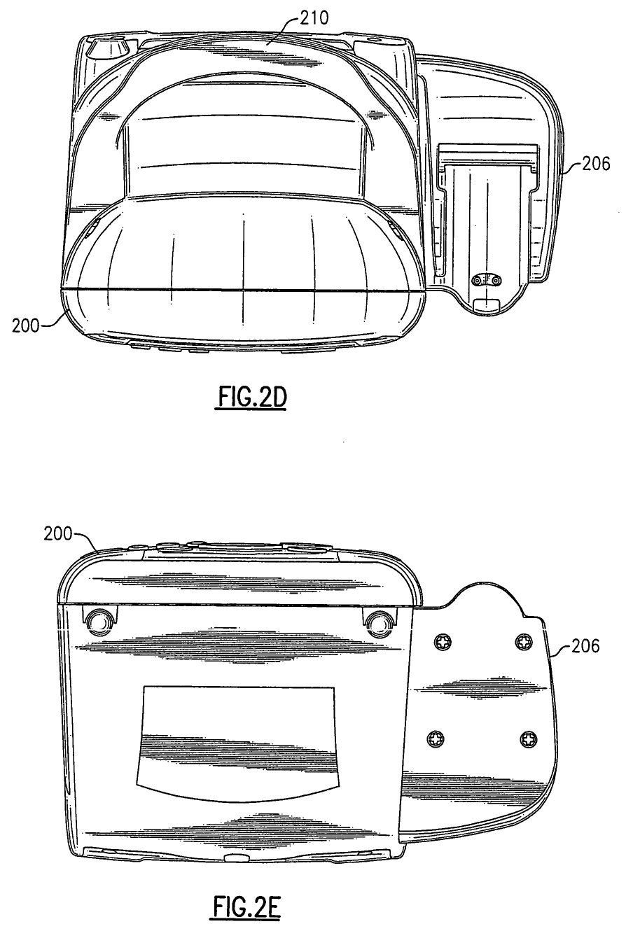

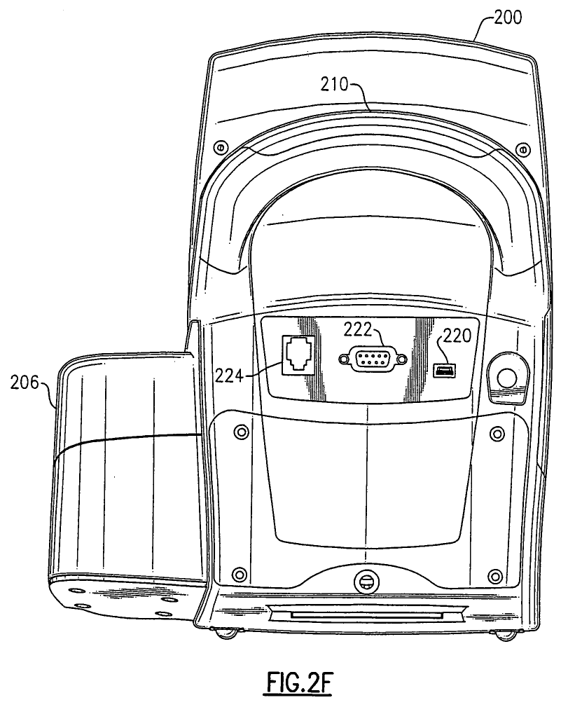

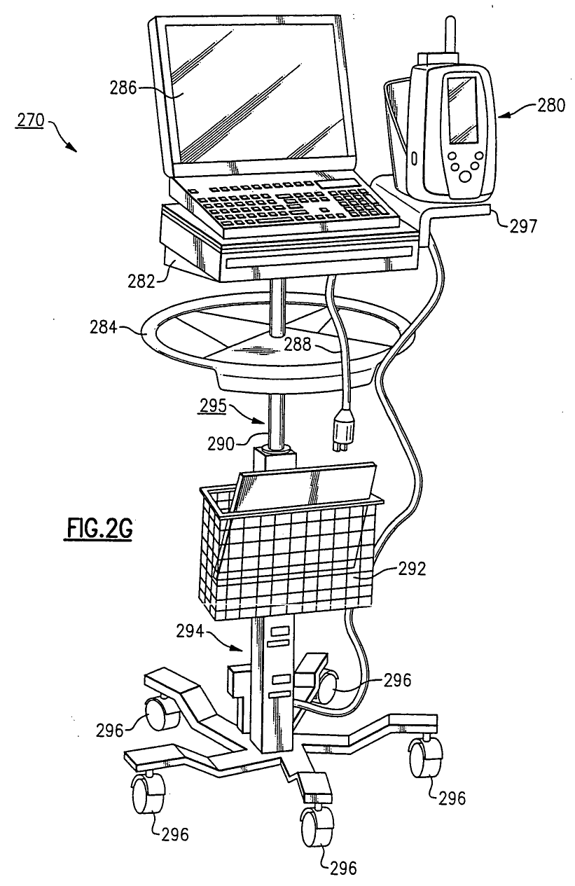

FIGS. 2A-2F are drawings in different views showing a second embodiment of the portable vital signs measurement instrument. FIG. 2A is a front elevation view of a portable vital signs monitoring instrument 200 showing a display 202 and a plurality of keys 204, as well as a well 206 for holding a thermometer instrument. FIG. 2B is a side elevation view of the portable vital signs monitoring instrument 200 showing the left side thereof relative to the view of FIG. 2A. In FIG. 2B there is shown a handle 210 for lifting, carrying, or pulling the portable vital signs monitoring instrument 200. Also shown in FIG. 2B is a connector 212 for a blood pressure cuff, and a connector 214 for a pulse oximetry connection FIG. 2C is a side elevation view of the portable vital signs monitoring instrument 200 showing the right side thereof relative to the view of FIG. 2A. The handle 210 is visible in FIG. 2C, as is the side of the well 206 for holding a thermometer. FIG. 2D is a top view of portable vital signs monitoring instrument 200, in which the handle 210 and the thermometer well 206 are visible. FIG. 2 E is a bottom view of the portable vital signs monitoring instrument 200, in which the thermometer well 206 is visible. FIG. 2 F is a rear elevation view of the portable vital signs monitoring instrument 200. In FIG. 2F there is visible the handle 210, and the thermometer well 206, as well as three connectors; connector 220 provides connection to a personal computer, connectors 222 and 224 are 9 wire serial connector, for example for an RS232 port. However, in other embodiments, different types of connectors can be used as one or both of connectors 222 and 224, such as an Ethernet, USB, or TTL Port.

The device is capable of being carried by hand or mounted on a mobile stand, in order to go from patient to patient and from room to room. A handle is provided to carry the device by hand and store a blood pressure cuff. A wall mount option is also available, comprising a wall mounting bracket with basket for accessories and transformer mount. The device provides a means, such as a wire basket, to store at least one large adult cuff assembly, at least one SpO₂ probe, at least one box of oral or ear temperature probe covers, and at least one oral or ear temperature probe while being moved. The device is also suitable for use with any of the Welch Allyn child cuff, the Welch Allyn Small Child Durable One-Piece Cuff, and the Welch Allyn Small Child Disposable One-Piece Cuff. The device provides a means, such as a pocket, to hold an adult cuff, regularly folded behind the handle of the device. A mounting fixture for the bar code scanner is included with an optional scanner. When placed on a horizontal surface, the device stands such that the display can be easily read. The device has secure footing to prevent the device from sliding on a table top. In one embodiment, a fully loaded unit, not including accessories, does not exceed a weight of 6.5 lbs.

To provide convenient portability and a convenient support structure for holding the portable vital signs measurement instrument in a position that is suitable for use and viewing by an operator, the portable vital signs measurement instrument is optionally mounted on a stand having one or more wheels for providing ease of mobility without a requirement to support the entire weight of the instrument. FIG. 2G is a drawing 270 showing an embodiment of the portable vital signs measurement instrument 280 mounted on a stand 290. The stand 290 can be any support structure that supports the portable vital signs measurement instrument 280 at a convenient height and in a convenient orientation for use by a medical practitioner. In one embodiment, the stand 290 is a five-point universal mobile stand with basket 292 and power strip/transformer mount 294 including a connector 288 for connecting to a wall outlet, and a plurality of wheels 296. In one embodiment, the support or stand is a frame, such as a pole 295 constructed from metallic tubular stock, and includes at least one structure for securely holding the portable vital signs measurement instrument, such as a horizontal surface 297 (with or without a restraining device), a hook attached to the frame that mates with a corresponding attachment point on the portable vital signs measurement instrument 280, or a mount similar to a wall mounting bracket. The stand 290 can additionally comprise a handle 284 for conveniently moving the stand 290, and can additionally comprise a support 282 for additional equipment, for example a general purpose laptop computer 286.

As used in the present application, certain terms have meanings according to those expressed in Table I.

TABLE I

| | |
|---|---|
| AAMI | Association for the Advancement of Medical |
| | Instrumentation |
| Backlighting | A method of shining light from behind an LCD display |
| | to provide visibility in dim lighting conditions |
| BHS | British Hypertension Society |
| Boot Loader | In a computer system, the portion of the system |
| | firmware which receives control following a hardware |
| | reset. In FLASH based systems typically the Boot |
| | Loader resides in it's own FLASH sector and is |
| | responsible for determining whether to launch the |
| | device's normal system firmware or jump to special |
| | firmware typically responsible for reprogramming the |
| | normal system firmware. |
| BP | Abbreviation for blood pressure |
| bps or BPS | Bits per second. |
| BMI | Body mass index, a measure based on the ratio of |
| | body weight to height that provides a guide to a |
| | person's relative state of underweight, normal |
| | weight or obesity; in children, BMI-for-age provides |
| | a measure of the potential that a child will become |
| | an obese adult |
| Cycle | The sequence of events that a device goes through |
| | to get one vital sign reading, for example, one |
| | blood pressure reading. |
| Enunciator | An output comprising either or both of a visual |
| | symbol and an audible sound. |
| Event | A specific device occurrence during a measurement or |
| | operational cycle. Events is grouped into an event |
| | log, which could act as a device's “black box” |
| | to record the history of user interface and |
| | device functionality. |
| Fail-safes | A set of redundant circuitry that provides assurance |
| | that a BP device cannot cause conditions that are |
| | dangerous to the patient it is being used on. |
| FLASH memory | Electrically erasable and programmable machine- |
| | readable memory. FLASH is a newer technology |
| | featuring very fast programming and high capacities. |
| H/W | Acronym for Hardware. |
| kPa | Unit of measurement for pressure. Used to measure |
| (Kilopascals) | blood pressure in China. |
| | 1 kPa = 7.5006 mmHg. |
| LCD (Liquid | A type of visual display on a device that shows |
| Crystal Display) | various combinations of numbers, letters, |
| | characters and special symbols. |
| LED (Light | A sold state device which emits one or more colors |
| Emitting Diode) | of light. Used as a visual indicator, such as for |
| | a state of a device. |
| MAP (Mean | The arterial pressure, averaged over one heart |
| Arterial | rate cycle. |
| Pressure) | Often taken as (2*DIA + SYS)/3 |
| MMC/SD | MultiMedia Card/Secure Digital. An industry standard |
| | peripheral card with small footprint typically |
| | containing mass storage, such as FLASH memory |
| mmHg | Common unit of measurement for blood pressure. |
| (Millimeters | 1 mmHg = 0.13332 kPa. |
| of mercury) | |
| NIBP (Non- | Blood pressure measurements performed outside of a |
| invasive Blood | patient's body, without entering a vessel through |
| Pressure) | the skin. |
| NIBP Record - | A data packet, or bundle, that contains information |
| Mod F | about a given NIBP cycle that includes; systolic, |
| | diastolic, MAP, heart rate, status and |
| | applicable error code(s). |
| Patient | A data packet, or bundle, that contains information |
| Record - | about a given patient or subject which may include: |
| Spot Ultra | date and time; systolic, diastolic and BP heart |
| | rate; temperature, probe type and method; SpO₂ % and |
| | heart rate; unit operational information; status' |
| | and applicable error codes. |
| POST | One or more self-testing procedures automatically |
| (Power-on | performed in the device after initially turning on |
| self test) | the device. Typically, most or all LCD elements are |
| | displayed for a short period of time, usually one |
| | to three seconds, followed by clearing the LCD |
| | screen and entering a ready state, which may |
| | display the idle state of all patient parameters. |
| | In addition, various hardware components are |
| | tested such as RAM, FLASH, etc. |
| Power-up | The act of turning the device on by pressing the |
| | On/Off button, or under remote control. Immediately |
| | following Power-Up the device enters POST. |
| RAM | Random Access Memory. Machine-readable memory |
| | which is infinitely writable and features equally |
| | fast access to any memory address. |
| Reading | Refers to individual reported vital signs data |
| | from a measuring device. Typically comprises at |
| | least one of systolic blood pressure, diastolic |
| | blood pressure, BP heart rate, and mean arterial |
| | pressure, temperature, SpO₂ %, SpO₂ heart rate and |
| | SpO₂ pleth. |
| Real Time | The constraint placed on the performance of a |
| | system in which processing of events takes place |
| | substantially without delay as perceived by a human |
| | operator or observer of the system. Real time |
| | operation typically requires that an operation is |
| | to be completed within a specified period of time. |
| Result | Refers to any applicable data from a measuring |
| | device that includes not only the vital signs data |
| | also but any additional error codes/icons/ |
| | annuciations associated with the measurement. |
| RTOS | Real Time Operating System, such as the ThreadX |
| | operating system used in Spot Ultra. |
| S/W | Acronym for Software. |
| Service | In a computer system, a software module without a |
| Module | control thread. Public functions offer services to |
| | System Modules. |
| Software | A software “object” which consists of |
| Module | encapsulated data and function objects and |
| | helper functions, “methods”, which access the |
| | data or manipulates functionality in a |
| | controlled manner. |
| System | A software module which contains one or more RTOS |
| Module | tasks. |
| Task | In older RTOS discussion, a Task is the fundamental |
| | program element in a system operating under an |
| | RTOS. A task is a semi-independent portion of the |
| | application that carries out a specific duty. |
| | An application may be composed of one or more tasks. |
| | The RTXC RTOS uses the term Task. |
| Thread | In contemporary RTOS discussion, a Thread is a |
| | semi-independent portion of the application that |
| | carries out a specific duty. In essence, use of the |
| | term Thread has more or less replaced use of the |
| | term Task. The ThreadX RTOS uses the term Thread. |
| USB | Universal Serial Bus. An industry standard bus for |
| | interfacing peripheral devices to a host PC. |
| VSM | Welch Allyn Vital Signs Monitor |

In one embodiment, the Spot Ultra instrument uses the Motorola DragonBall™ MXL microcontroller, FLASH memory, RAM, and various Welch Allyn and third party hardware components. In one embodiment, the software is compiled with a “C” language compiler and operates with a Real Time Operating System (for example, the ThreadX RTOS available from Express Logic Inc of San Diego, Calif.).

System Architecture

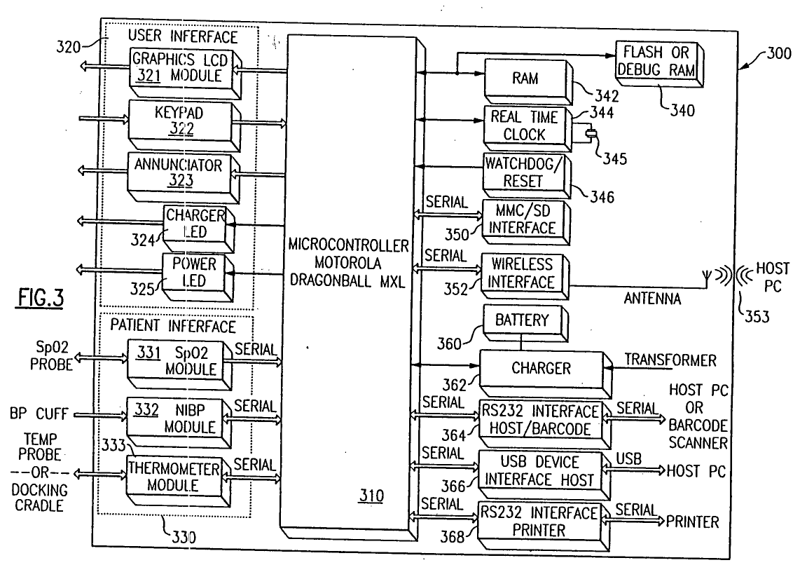

FIG. 3 is a diagram that illustrates a preferred embodiment of the overall system architecture 300 of the Spot Ultra vial signs monitoring instrument. In a preferred embodiment, a microcontroller 310 is provided, such as the Motorola DragonBall™ MXL microcontroller available from Motorola, Inc. of Schaumburg, Ill. Other microcontrollers, such as those manufactured by Intel or other semiconductor manufacturers, can be substituted for the DragonBall™ MXL microcontroller.

The exemplary vital signs measurement instrument comprises a real time clock/calendar, a watchdog/reset timer, a non-volatile storage, a NIBP that employs the Mod F fast blood pressure algorithm, a thermometry unit, an SpO₂ sensor (such as the Nellcor MP506 available from Nellcor of Pleasanton, Calif. or the Masimo MS-11 unit available from Masimo Inc. of Irvine, Calif.), a user interface module, a printer such as a 2″ external thermal printer, a bar code scanner such as the Hand Held Products' Image Team linear scanner, a connectivity module, an external charger, and a memory card such as a MMC/SD card. The user interface module in one embodiment comprises one or more of a display, such as a ¼ VGA Graphics LCD display available from Nan Ya of Taipei County, Taiwan, a data entry module such as a keypad, an audio enunciator, and one or more LEDs that annunciate a power condition of the instrument, a state of charge of a battery, and a state of operation of a charger. Each component of the portable vital signs monitor instrument is described in greater detail below.

User Interface

The microcontroller 310 interacts with a user interface 320. The user interface 320 comprises a Graphics LCD module 321, which is described in one embodiment herein as the LCD display 402 of FIG. 4. While communication is shown in FIG. 3 as being unidirectional from the microcontroller 310 to the Graphics Display 321, in other embodiments, the LCD display 302 can be replaced with a touch screen display which will allow bi-directional communication. The Graphics LCD display 321 that allows bi-directional communication provides for example the capabilities of navigation through program menus, and manual entry of information such as height, weight, pain indications, respirations, and directing the calculation of BMI when height and weight are entered. In the absence of a display capable of bi-directional communication, the same information can be entered using a keyboard, keypad or other data entry device. Height and weight can be entered in any convenient units, such as English units or metric units.

User Interface Features

The operator can perform the following functions on the unit: start and stop an SPO₂ reading; start and stop a temperature reading, including selecting Axillary (pediatric or adult) or Oral Mode; Fahrenheit (F) or Centigrade (C); and predict and monitor mode; connect via RS232 to a weight scale and capture weight; initiate a print of the data displayed; scan a patient and/or clinician ID; enter data, including pain level; respiration rate; height; and weight; erase patient record memory, including either the records for an individual patient, or all entries recorded in memory; and calculate BMI.

Keypad

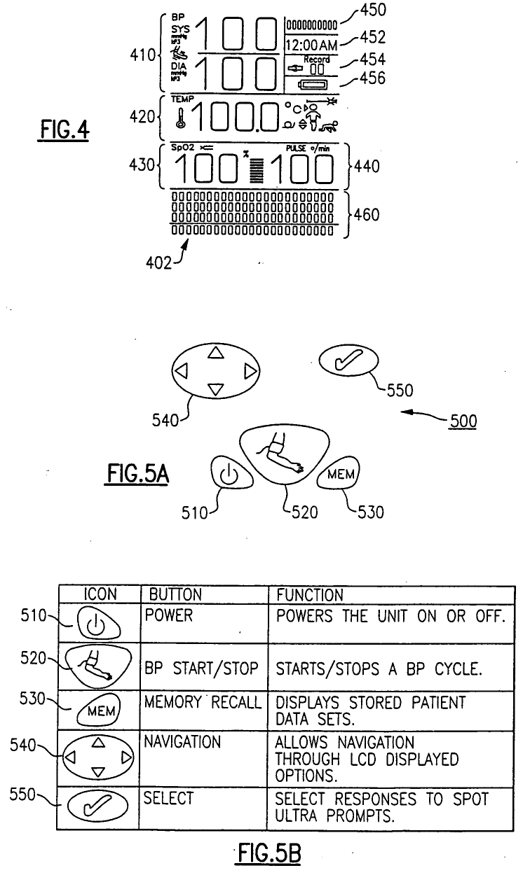

In the embodiment depicted, the user interface 320 also comprises a keypad 322 for receiving user input and communicating that input to the microcontroller 310. In one embodiment, the keypad 322 is the keypad 500 of FIG. 5A, in which the individual buttons operate as described in FIG. 5B and the accompanying discussion hereinbelow.

Enunciator

In the embodiment depicted, the user interface 320 also comprises an enunciator 323, such as an audible signaling device. In one embodiment, the enunciator is a simple beeper, for example located on the portable vital signs measurement instrument main circuit board and audible to a user when activated.

Patient Interface

The microcontroller 310 interacts with a patient interface 330. In the embodiment depicted, the patient interface 330 comprises a SpO₂ module 331. The SpO₂ module 331 connects to a probe that monitors biometric signals, such as optical response of the finger of a patient to one or more kinds of applied illumination that can be interpreted to deduce a value for SpO₂. The probe provides electrical signals obtained by manipulating the biometric signals for provision to the microcontroller 310 by way of the SpO₂ module 331. In some embodiments, the microcontroller 310 can issue commands to the SpO₂ module 331, for example commands to begin a measurement of SpO₂, and commands to return at least one datum that can be interpreted as an SpO₂ reading. SpO₂ is expressed in units of percent (%).

SpO₂

Portable vital signs measurement instrument optionally comprises one of two SpO₂ options: the Nellcor MP506 OEM module or the Masimo MS-11 OEM module.

Nellcor MP506

Power to the Nellcor MP506 OEM module is controllable by the portable vital signs measurement instrument. Communications between the portable vital signs measurement instrument and the Nellcor MP506 OEM module is uni-directional (from the SpO₂ to the portable vital signs measurement instrument only), serial and uses the software interface of the Nellcor MP506 OEM module. Communications are implemented using a hardware UART.

In general, for the purposes contemplated herein, communications can be performed between two devices at any rate that is sufficient to provide real time operation. Today, data transfer rates using serial ports can be performed at rates as high as 115 kiloBaud. For other type of data transfer, including methods such as radio and optical wireless communication, data rates in the mega- and giga-bit per second range are possible, but can be expensive. It is expected that in the future, even higher rates of data transfer will be available at reasonable cost.

Masimo MS-11

Power to the Masimo MS-11 OEM module is controllable by the portable vital signs measurement instrument. Communications between the portable vital signs measurement instrument and the Masimo MS-11 OEM module is uni-directional (from the SpO₂ to the portable vital signs measurement instrument only), serial and uses the software interface of the Masimo MS-11 OEM module. Communications are implemented using a hardware UART.

NIBP

In the embodiment depicted, the patient interface 330 comprises an NIBP module 332. The NIBP module 332 operates with a blood pressure cuff, as described in greater detail in U.S. patent application Ser. No. 10/619,380. The portable vital signs measurement instrument uses the NIBP Mod F Module. Power to the module is controllable by the portable vital signs measurement instrument. In some embodiments, the microcontroller 310 and the NIBP module 332 interact bi-directionally, serial. In one embodiment, communication is implemented with the Welch Allyn SNIFF Protocol and the VSM Serial Communications Protocol as defined in the Mod F Communications Specifications. Communications are implemented using a hardware UART.

Thermometry

In the embodiment depicted, the patient interface 330 comprises a thermometer module 333. In some embodiments, the thermometer module 333 is a thermometry unit capable of measuring a patient temperature, such as a selected one of the Welch Allyn SureTemp® Plus OEM module or the Braun Pro4000 OEM module.

SureTemp® Plus OEM

The SureTemp Plus® is a thermometer that provides any of oral thermometry, adult and pediatric axillary thermometry, and rectal thermometry, with a sealed removable probe well. Power to the SureTemp® Plus OEM module is controllable by the portable vital signs measurement instrument. Communications between the portable vital signs measurement instrument and the SureTemp® Plus OEM module is bi-directional, serial, using the VSM Serial Communications Protocol, and complying with the SureTemp® Plus Communications Specification. Communications are implemented using a hardware UART.

Braun Pro4000

The Braun Pro4000 is a thermometer that provides tympanic thermometry (e.g., measurement of temperature in the ear). Power to the Braun Pro4000 module is controllable by the portable vital signs measurement instrument. Communications between the portable vital signs measurement instrument and the Braun Pro4000 module is half duplex, current loop serial, using the Braun Pro4000 Communications Specification. Communications are implemented using a hardware UART.

Memory

In the embodiment depicted, the microcontroller 310 also is in electrical communication with flash memory 340 or debug memory 340; RAM 342; a real time clock 344, which real time clock 344 in some embodiments uses a crystal 345 as an oscillator to provide a highly accurate timing signal; and a watchdog/reset timer 346. The flash memory 340, RAM 342, real time clock 344 and watchdog/reset timer 346 are described herein in greater detail.

Non-Volatile Storage

Configuration

The portable vital signs measurement instrument comprises non-volatile storage used to store such configuration information as a device serial number, a language selection, and a list of components and software modules included in the instrument. Configuration storage is implemented using dedicated sectors of the program code recorded in FLASH memory.

Event Logging

The portable vital signs measurement instrument comprises non-volatile storage used to store an event log. The event log is used to record the history of user interface and device functionality (i.e., that a button press occurred, that an out of tolerance condition occurred some functional system, or that some other event took place the knowledge of which would be useful in maintaining the instrument). Event logging storage is implemented using dedicated sectors of the program code recorded in FLASH memory.

Data Collection and Patient Data Storage

The portable vital signs measurement instrument comprises non-volatile storage used for data collection. The data collected is used for recording patient vital signs. In one embodiment, data collection storage is implemented using a Secure Digital (SD) Memory Card. The portable vital signs measurement instrument comprises non-volatile storage to store up to 50 patient records even if the power to the unit is turned off.

Communication Interfaces

In the embodiment depicted, the microcontroller 310 is in bi-directional electrical communication with interfaces, including a machine-readable memory module, such as MMC/SD interface 350 that can accommodate a MMC/SD memory device, and wireless interface 352, which in some embodiments is a radio interface using an antenna 353 to communicate with a host PC or server. In other embodiments, the wireless interface 352 in an optical or infrared interface that communicates wirelessly with a host PC or server by infrared, visible, or ultraviolet electromagnetic signals. The interfaces 350, 352 can be used by the microcontroller 310 to send information, such as data and commands, to the host PC, and can receive information, such as data, commands, and files, including program files, from the host PC by way of the interfaces. In particular, reprogramming the microcontroller 310 by retrieving a program module containing at least one instruction from any of the flash memory 340, the RAM 344, the MMC/SD interface 350, and the wireless interface 352 is contemplated. In some embodiments, the microcontroller 310 can also comprise a conventional hardwired communication channel.

Battery and Battery Charger

In the embodiment depicted, the microcontroller 310 is in bi-directional electrical communication with a battery 360 and a battery charger 362. The battery charger 362 is in electrical connection with a remote source of electrical power, for example a wall mains supply intermediated by a transformer to adjust a voltage level to that required by the battery charger 362. The battery charger 362 in some embodiments is configured to sense a state of charge of the battery 360, and to provide power to the battery 360 to increase its state of charge as may be required. In the embodiment depicted, the user interface 320 also comprises a charger LED 324 and a power LED 325, which LEDs signal the state of a charge of the battery 360, whether the battery is being charged, and whether the power is on or off to the portable vital signs measurement instrument, respectively. LEDs 324 and 325 operate in cooperation with the battery 360 and the battery charger 362. Rechargeable storage batteries, battery chargers and control circuits for automatically adjusting the operation thereof in conjuction with battery-powered equipment are well known, and are not critical features of the present invention; they will not be described in detail herein. See, for example, http://www.industrialnewsroom.com/fullstory/450882, which states that on Apr. 19, 2004, Linear Technology Corporation of Milpitas, Calif. introduced the LTC4068, a standalone linear single-cell Li-Ion Lithium Polymer battery charger that allows system designers to program charge cycle termination properly with a system load concurrently applied to the battery. Many other automated battery charging controls are known.

Real Time Clock/Calendar

The portable vital signs measurement instrument comprises a real time clock/calendar that is used to time stamp patient data. A real time clock 344 in some embodiments uses a crystal 345 as an oscillator to provide a highly accurate timing signal. The time stamp comprises a part of any patient data displayed or output generated by the portable vital signs measurement instrument. The time stamp can include a date, a time, and a day of the week, in format that is originally defined as a default (for example, American date format, e.g., MM/DD/YYYY, and 12 hour clock with AM and PM designators) and that can be reconfigured by a user or an administrator to display in alternative formats (such as International date format, e.g., DD/MM/YYYY, and 24 hour clock).

Watchdog/Reset Timer

The portable vital signs measurement instrument comprises an external watchdog and reset component which is used to reset the portable vital signs measurement instrument in the case of system malfunctions. The watchdog component periodically checks the operation of the portable vital signs measurement instrument to check that the instrument is not “hung up” in a loop condition, or otherwise operating inappropriately.

User Interface

The user interface has been described above as to the components thereof. In one embodiment, the LCD display and keypad comprise a subsystem which is connected the portable vital signs measurement instrument main circuit board by a flat ribbon cable.

LCD Display

The Nan Ya ¼ VGA Graphics LCD display is implemented on a separate assembly, including the LCD and ballast. The interface to the LCD by the MXL's LCD controller is unidirectional and uses the hardware interface required of the Nan Ya LCD Display. FIG. 4 shows the layout of the LCD display 402.

The LCD Display 402 includes a region 410 for displaying information relating to a blood pressure measurement, identified by the alphanumeric identifier “BP” and by an illustration in miniature of a blood pressure cuff on an extremity of a person. The region 410 includes alphanumeric display segments for systolic blood pressure comprising an identifier (SYS), a numeric three digit display (shown as the number 100), and units of measure comprising two alphanumeric indicators (“mmHg” and “kPa”) only one of which is active at any time. The region 410 includes alphanumeric display segments for diastolic blood pressure comprising an alphanumeric identifier (DIA), a numeric three digit display (shown as the number 100), and units of measure comprising two alphanumeric indicators (“mmHg” and “kPa”) only one of which is active at any time. In one embodiment, the range of systolic pressure measurements is 60-250 mmHg and the range of diastolic pressure measurements is 30-160 mmHg. In some embodiments, the range of cuff pressures is 0-300 mmHg. In one embodiment, the range of MAP is 40-190 mmHg. The unit toggles between MAP and standard BP parameters, i.e., Systolic and Diastolic, when turned on in Internal Configuration Settings.

The LCD display 402 comprises a region 420 for displaying information relating to a temperature including an alphanumeric identifier (“TEMP”) and a graphic symbol reminiscent of a thermometer. In one embodiment, the range of temperature measurement is 80° F.-110° F., regardless of how or where measured. The region 420 also comprises a numerical display having four digits of display, indicated as 100.0, a degree symbol (°), a scale identifier for Centigrade (Celsius) or Fahrenheit scale (shown as “C”), an enunciator reminiscent of a snail for indicating that the measurement is still progressing, an ideograph of a person with an open mouth (indicating an oral temperature measurement), an ideograph of a person draped over a support (indicating a rectal temperature measurement.

The LCD display 402 comprises a region 430 for displaying information about an SpO₂ reading, having an alphanumeric identifier (“SpO₂”), a numeric display (represented as the value “100%”), and a pleth display. In one embodiment, the range of O₂ saturation is 40%-100%.

In one embodiment, the range of MAP is 40-190 mmHg.

The LCD display 402 comprises a region 440 for displaying information about a pulse reading, having an alphanumeric identifier (“PULSE”) in units of beats per minute (bpm) (identified as “♥/min”), a numeric display (represented as the value “100”), and an ideograph represented by a vertical bar graph indicating the strength of each pulse as measured by the SpO₂ module. In some embodiments, the display 402 presents the pulse rate determined by the last BP cycle or, if SpO₂ monitoring is active, as determined by the SpO₂ module. In some embodiments, the range of pulse rates is 25-245 bpm, when using SpO₂ module, and 35-199 bpm, when using the BP measurement.

The LCD display 402 comprises a region 450 that can display a plurality of symbols; a region 452 that is used to display time (shown as “12:00 AM”); a region 454 for indicating a record identifier, such as a two digit number; and a region 456 for identifying a state of charge of a battery by means of an ideograph of a battery having a bar graph therein indicative of the relative state of charge.

The LCD 402 also comprises a region 460 that is a display area for displaying a plurality of lines of alphanumeric information.

In one embodiment, the display 402 is readable from an 8-foot distance and over a ±30° viewing angle in a dimly or well-lit room. In some embodiments the display is allowed to turn off at a user-configurable time after completion of a BP, temperature, or SpO₂ cycle and/or last keypad activity in order to conserve energy. The depression of any button, other than the Power button, restores the display to the contents it had at the time it was blanked. In some embodiments, the initiation of a BP cycle restores the display to show the inflating cuff pressure in either mmHg or kPa units. In some embodiments, the initiation of a temperature reading restores the display to show the temperature self check. In some embodiments, icons may be used to indicate the state of the instrument to the user.

The instrument can display a variety of indications to a user. The unit displays an indicator that a connection is active. The unit displays the number of stored patient “cycles” or records. The unit displays motion indicator and/or an error codes with description if motion forces the unit to switch to a step deflate. The unit displays numeric error codes with descriptions in the status areas of the display. The unit includes a display of a 10-character device identifier. If no device identifier is specified this will hold the date. The unit is capable of displaying the Patient or Clinician ID.

The unit displays height in either inch or cm units. The device computes and displays body mass index scores. The device displays pain levels from 0 to 10 units. The device displays respirations per minute from 1 to 99 units. The unit reserves an area of the screen near the navigation buttons to display options and text messages.

Keypad

FIG. 5A is a diagram of a keypad 500 having a plurality of buttons therein. In the embodiment depicted, the keypad 500 comprises 5 isoelastomer buttons 510, 520, 530, 540, 550 laid out on the LCD circuit assembly. The keypad buttons 510, 520, 530, 540, 550 serve multiple purposes depending of the current mode of operation. FIG. 5B describes the primary function for each button when the device is operating in a normal mode of operation. Button 510 is a toggle type switch that turns power to the instrument on with a first press and off with a second press. Button 520 is a toggle type switch that turns on a blood pressure measurement with a first press and off with a second press. Button 530 displays stored patient data sets successively as it is repeatedly pressed. Button 540 is a navigation button, providing the function of a pointing device (or four arrow cursors as on a computer keyboard). Button 550 is a selection or activation button, such as a mouse button, that allows a user to select a currently highlighted or identified command.

Using the buttons 510, 520, 530, 540, 550, the operator can control the operating functions of the portable vital signs monitoring instrument as follows: On/Off

The button 510 turns power on and off. Upon power up, the unit performs a power-on-self-test (POST). When the self-test is completed successfully, all displays assume their normal functions and the unit is ready for operation. If the self-test fails, an error indicator and text message are displayed. When unit is turned off, all stored BP cycle data is saved in non-volatile memory.

BP Start/Cancel

The button 520 starts a new BP cycle, unless one is already in progress. If the button is pressed while a BP cycle is in progress, the cycle is aborted and cuff pressure is immediately released. An abort error message for the current cycle is displayed.

Memory Recall Button

If the button 530 is pressed, the unit displays basic memory mode—the last memory cycle and provide a means to scroll through all available cycles. Pressing the button again causes the unit to display advanced memory mode where all records are shown in tabular mode and the user can sort by timestamp or patient ID. Pressing the button once again returns the user to the main clinical screen (also referred to as the “dashboard”).

Navigation Button

The button 540 is used to navigate through selection options displayed by the unit.

Select Button

The button 550 is used to select an option displayed by the unit in the navigation window.

Internal Configuration Settings (Biomed Service Mode)

The configuration mode is not easily accessed by inadvertent actuation of the end-user. When powered up in configuration mode, the unit performs a power-on-self-test (POST). When the self-test is completed successfully, the display takes on its configuration mode function and the unit is ready for operation. If the self-test fails, an error indicator and message is displayed. While in configuration mode, all clinical parameters are disabled and the operator is able to perform the following functions on the unit:

The instrument can display a variety of information about its state and/or the components available in the unit to a user. The instrument can display the S/W revision numbers of all unit components. The instrument user can check the unit calibration by displaying the current cuff pressure. The instrument can display hardware version, manufacturer model number, manufacturer serial number, battery voltage, and blood pressure life cycles.

The user is able to select and adjust the month, day and year. The user is able to increment and decrement the individual date elements. The device does not allow for adjustment to invalid dates including consideration of the leap year. The user has multiple chances at changing the time without having to repeat the power on steps. The user is able to select and adjust the hour and minute. The user is able to increment and decrement the individual time elements. The device does not allow for adjustment to invalid times. The user has multiple chances at changing the time without having to repeat the power on steps.

The user can set the amount of time before the SpO₂ permanently goes off the display when the unit is in Auto Save Mode. The time can be selected in 1 minute increments from 0 to 5 minutes. The default value is to 2 minutes. Manual Save Mode requires the SpO₂ be accepted by the operator.

The user can modify the timeout time to initiate power down, in a range of from 1 minute to 60 minutes by 1-minute increments. The default time is set to 30 minutes.

For SureTemp Plus, the operator can choose Oral or Pediatric Axillary or Adult Axillary mode as the preset. In one embodiment, oral is the default mode. For SureTemp Plus or Braun, the user can choose as temperature display units either ° F. or ° C. In one embodiment, OF is the default mode.

The user is able to specify and/or view the radio's physical address and network identifier. The user is also able to enter the address of a printer or weight scale to reduce the time it takes for device discovery, if an address for such a device is known.

In one embodiment all Wi-Fi units operating on a single network to have the same SSID. The user can set the Wi-Fi access point SSID.

The user can set the Wi-Fi 128 bit encryption key. It is necessary to set all Wi-Fi units operating on a single network to have the same encryption key.

The user can set the Wi-Fi channel. It is necessary to set all Wi-Fi units operating on a single network to have the same channel. The default channel is set to 11.

The user can set the location identifier. The user is able to specify the unit's location. If the memory location for the unit location is empty, the unit will display the date.

The user can enable or disable weight and can enable or disable height.

The user can set the memory mode. In one embodiment, an automatic memory mode is used. The unit automatically saves into memory the parameters measured in succession before a preconfigured amount of time between parameter readings expires. The preconfigured amount of time is 0 to 5 minutes in 30-second increments, then in 1-minute increments to 10 minutes. If the preconfigured amount of time for the unit to power down is less than the preconfigured amount of time for the unit to automatically save a cycle into memory, the unit will save the cycle first, and then power down.

In one embodiment, a manual memory mode is used. The user must elect to accept each parameter and finally to save for each cycle in memory. If, however, the user does not save the cycle, the unit automatically saves into memory the parameters measured before a preconfigured amount of time expires. The preconfigured amount of time is 0 to 5 minutes in 30-second increments, then in 1-minute increments to 30 minutes. If the preconfigured amount of time for the unit to power down is less than the preconfigured amount of time for the unit to automatically save a cycle into memory, the unit will save the cycle first, and then power down. The default memory mode is the automatic mode.

The user can set save time length.

The user can set default values. Blood pressure (BP) units toggle from mmHg to kPa; the default is mmHg. Weight units toggle from lb to kg; the default is lb. Height units toggle from in to cm; the default is inches. MAP calculations toggle on/off; the default mode is off. Require Clinician ID toggles on/off; the default is off. Require Patient ID toggles on/off; the default is off. Require Respiration Rate toggles on/off; the default is off. Require Pain Level toggles on/off; the default is off. Require BMI toggles calculation on/off; the default is off.

Power/Charger LEDs

In one embodiment, a power LED provides visual indication of the On/Off state of the portable vital signs measurement instrument. A charger LED provides a visual indication whether the portable vital signs measurement instrument is plugged into a charger, and whether the battery is being charged, or is fully charged.

Printer

The portable vital signs measurement instrument uses an optional external printer. Communications with the printer may be bi-directional (e.g., from the portable vital signs measurement instrument to printer, and from printer to the portable vital signs measurement instrument), serial and uses the software/hardware interface of the external printer. Communication is implemented using a hardware UART. Bar Code Scanner Optionally, in some embodiments, the portable vital signs measurement instrument uses a pre-configured Hand Held Products' ImageTeam linear bar code scanner. Communication between Portable vital signs measurement instrument and the bar code scanner is uni-directional (bar code scanner to Portable vital signs measurement instrument only), serial, and uses the software interface defined in the Portable vital signs measurement instrument Communications Specification. Communication is implemented using a hardware UART.

Connectivity

RS-232 Serial Interface—Host/Barcode

In one embodiment, an RS-232 serial interface provides a connection to either a host PC or a barcode scanner. The interface comprises a DB-9F connector using pin assignments compatible with PC and barcode scanner use. Communication is implemented using a hardware UART. The unit can indicate to the user the connectivity status.

Host

Communications between the portable vital signs measurement instrument and a PC host is bi-directional, using the Welch Allyn Common Communications Interface SNIFF Protocol, the VSM Serial Communications Protocol (the “Spot Ultra Check Device Serial Communications Specification”), and the Welch Allyn WACP Communications Protocol and COOA Specification. The portable vital signs measurement instrument is responsible for handling the communications between a PC host and the NIBP Module F in a seamless manner for purposes for factory test and module programming.

Barcode Scanner

Communication between the portable vital signs measurement instrument and a pre-configured Hand Held Products ImageTeam 1-D linear barcode scanner is supported as noted herein. In other embodiments, other types of hand held optical readers may be employed, for example a 2-D barcode scanner or reader.

USB 1.1 Device Interface

The portable vital signs measurement instrument provides a USB 2.0, 1.1 subset certified device interface for connection to a host PC. The interface comprises a standard USB mini-B connector. Communication is implemented using the MXL's internal USB device controller. Communication between the portable vital signs measurement instrument and a PC host is bi-directional, using the Welch Allyn Common Communications Interface SNIFF Protocol, the VSM Serial Communications Protocol and the Welch Allyn WACP Communications Protocol and COOA Specification.

RS-232 Serial Interface—Printer

In some embodiments, a second RS-232 serial interface provides a connection to an external printer. The interface comprises a RJ-45 6-pin connector. Communications are implemented using a hardware UART. Communication between the portable vital signs measurement instrument and the printer through this interface is performed as noted herein.

Wireless

In one embodiment, the portable vital signs measurement instrument provides a 802.11b wireless interface using an IEEE 802.11B compliant OEM module. Power to the 802.11B OEM module is controllable by the portable vital signs measurement instrument. Communications between the portable vital signs measurement instrument and the 802.11 OEM module is bi-directional (e.g., 802.11 OEM module to the portable vital signs measurement instrument, and the portable vital signs measurement instrument to 802.11 OEM module), serial and is performed according to the software interface of the 802.11 OEM module. Communications are implemented using a hardware UART. Higher data rates are possible if a communication channel other than a serial communication link is used between the portable vital signs measurement instrument and the 802.11b OEM module, for example using parallel communication, Ethernet communication, or fast serial communication up to 1 Mbps. The 802.11b wireless interface provides a connection to a host PC or server. Communication between the portable vital signs measurement instrument and a PC host or server is bi-directional, using the Welch Allyn Common Communications Interface SNIFF Protocol, the VSM Serial Communications Protocol, and the Welch Allyn WACP Communications Protocol and COOA Specification.

External Charger

The internal battery is charged via an external medical grade charger. The portable vital signs measurement instrument hardware and software controls the rate and degree of charging allowed and provides visual cues as to the state of battery charge and the connected state to an external charger.

MMC/SD

The portable vital signs measurement instrument may use a Secure Digital (SD) Memory Card as a machine-readable memory for collecting data for use in NIBP Mod F algorithm development, in compliance testing and in validation.

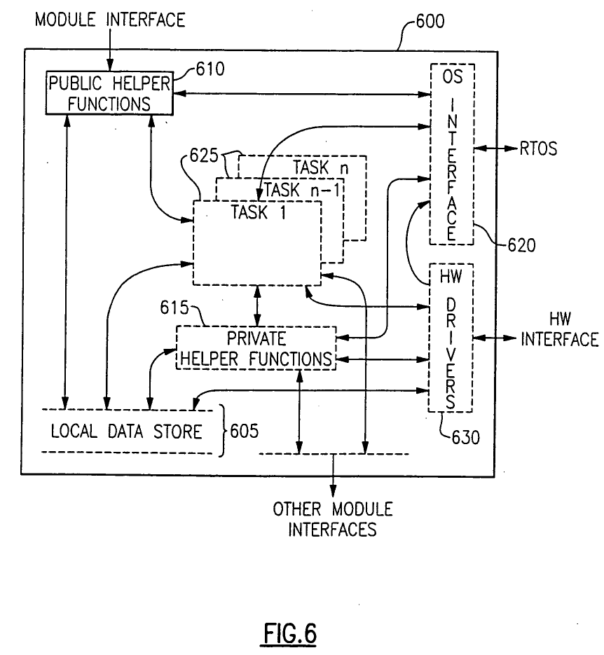

FIG. 6 is a diagram depicting the software architecture of a generic software module 600 of an embodiment of the portable vital signs measurement instrument. The portable vital signs measurement instrument software architecture is based on a pseudo object oriented design model. Object oriented programming is a programming method that is well known and will not be described in great detail herein. See for example, Object-Oriented Programming by Peter Coad and Jill Nicola, published by Prentice Hall PTR in 1993. Each software module 600 or “object” comprises encapsulated data 605 and function objects and helper functions 610, 615, and “methods” that access the data or manipulate functionality in a controlled manner. Most modules contain one or more RTOS threads which implements the main functionality of the module, and that communicate with the RTOS using an operating system interface 620. The threads operate as tasks 625. Communications between threads usually performed with messages or semaphores. Message passing and event signaling (using semaphores) is generally encapsulated within each module; outside access is done with helper functions. As required, an object 600 can interact with hardware using a hardware interface 630. Most of the goals of object oriented design can be achieved following these guidelines, using only a regular C-compiler.

Implementation of the ThreadX Real-Time Kernel

To ease portability, a relatively small subset of available ThreadX services is utilized. In one embodiment, only preemptive thread scheduling is used. This means that no two threads have the same priority. Only static threads are employed. Kernel objects that are used to their full potential are threads, semaphores, message queues, memory partitions, mutexes and timers. No threads are ever terminated. A mutex (or mutual exclusion object) is a program object that allows multiple program threads to share the same resource, such as file access, sequentially, but not simultaneously. When a program is started, a mutex is created with a unique name. After this stage, any thread that needs the resource must lock the mutex from other threads while it is using the resource. The mutex is set to unlock when the data is no longer needed or the routine is finished.

The portable vital signs measurement instrument operates in a multi-threading fashion. The portable vital signs measurement instrument allows for the execution of a blood pressure cycle, a temperature measurement, and SP⁰² monitoring concurrently. The portable vital signs measurement instrument can communicate to an external host PC by any of the RS-232 serial, USB and 802.11b wireless interfaces concurrently with any ongoing vital signs measurement(s). It is responsive to user interaction via the user interface. It monitors its own operational parameters to insure that its environment is able to support both accurate measure and patient safety. Within the portable vital signs measurement instrument software, event passing from one subsystem to one or more receiving subsystems occurs using one message queue for each receiving subsystem.

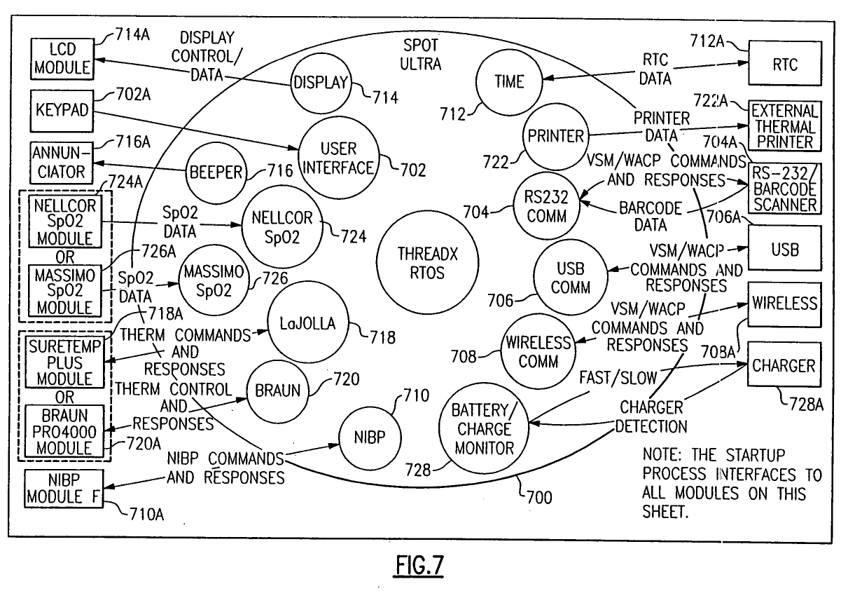

FIG. 7 is a diagram that illustrates the interaction of the portable vital signs measurement instrument software 700, including system modules, with the hardware of the portable vital signs measurement instrument through external interfaces. The Startup process interfaces to all modules of FIG. 7.

User Interface Module

The User Interface (UI) module 702 is responsible for handling button presses from the keypad 702A and processing requests from other software modules for changes in the operation of the device. The UI 702 is the primary control module for the device; providing an extensive set of public functions for use by the other software modules. It operates as a state machine, keeping track of and changing the system state, based on the current system state and events which may cause a change of state.

Communications Modules: RS232 Comm, USB Comm, Wireless Comm

The communication modules for RS232 (RS232 Comm 704), USB (USB Comm 706), and wireless (Wireless Comm 708) handle all communications between the device and an external device, such as a PC, in a concurrent manner. The RS232 Comm 704 communicates bi-directionally with RS232 hardware 704A and receives data from the pre-configured barcode scanner hardware 704A. The USB Comm 706 communicates bi-directionally with USB hardware 706A. The Wireless Comm 708 communicates bidirectionally with wireless hardware 708A. The modules 704, 706, 708 process commands received and responds to supported commands accordingly. If the command is not supported by the device or the command pass through flag is set, the command is re-directed to the NIBP module 710 and to the NIBP Module F 710A sub-system for processing; the device then returns the NIBP module's response to the command to the external device that initiated the command. The communication modules 704, 706, 708 are capable of handling the Welch Allyn Common Communications Interface SNIFF Protocol, the VSM Serial Communications Protocol, and the Welch Allyn WACP Communications Protocol and COOA Specification.

NIBP Module

The NIBP module 710 communicates with the NIBP Module F sub-system and is responsible for monitoring and controlling the NIBP modality.

Time Module

The Time module 712 maintains various device timers, including the 10 ms. tick timer, the one and two second flash timers, and the system time. It runs off a hardware timer RTC 712A with a 10 ms. interval.

Display Module

The Display module 714 communicates with an LCD hardware device 714A, such as the LCD display described in FIG. 4. The Display module 714 provides the ability to update the display of any of the major fields on the LCD 714A including systolic and diastolic blood pressure, heart rate, SpO₂% and pleth, and temperature, as well as individual symbols (such as the heart, thermometer probe.). It also provides the ability to turn on or off all LCD pixels via a single message.

Beeper Module

The Beeper module 716 handles controlled access to the audio enunciator hardware 716A. It provides several different types of enunciator outputs, for example different tones, different signal patterns, and/or different signal intensity (e.g., audio volume).

Thermometer Modules

The thermometer modules LaJolla module 718 and Braun module 720 communicate, depending on which option is installed, with either the SureTemp® Plus OEM hardware 718A sub-system or the Braun Pro4000 hardware 720A by way of its docking cradle and are responsible for monitoring and controlling the thermometer modality.

Printer Module

The Printer module 722 is responsible for handling requests to print to the external thermal printer 722A. The Printer module 722 handles the various printout selections and the formatting of the output as may be required.

SpO₂ Modules

The Nellcor MP506 SpO₂ module 724 handles communications with the Nellcor OEM hardware module 724A, and the Masimo MS11 SpO₂ module 726 handles communications with the Masimo OEM SpO₂ hardware module 726A, depending on which option is installed. The modules 724, 726 capture the data stream from the hardware module, parse the data and format the resulting data into a SpO₂ data record. The modules 724, 726 also issue display update requests for the SpO₂% and pleth to the Display module 714. The modules 724, 726 also handle SpO₂ sensor error detection and notification.

Battery/Charge Monitor Module

The Battery/Charge Monitor module 728 is responsible for determining if a charger 728A is plugged in; determining a rate of battery charging (e.g., fast or slow); determining if the battery voltage level is low; and controlling the state of the battery/charging LCD icon and LED displays.

Service Modules

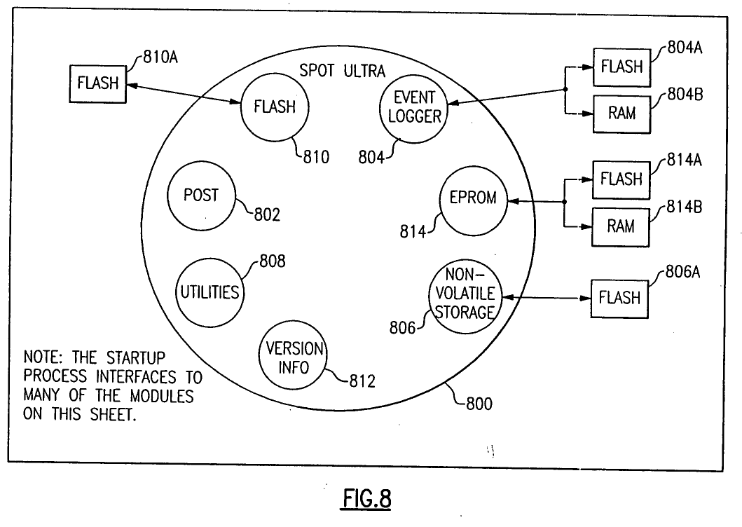

FIG. 8 is a diagram that illustrates the interaction of the portable vital signs measurement instrument software 800, including service modules, with hardware components of the portable vital signs measurement instrument. Service Modules are similar to system modules except that they do not contain RTOS threads and may in fact contain only a set of public helper functions. The service modules provide a set of services for use by other service modules or system modules. The Startup process interfaces to all modules of FIG. 8.

POST Module

The POST (Power On Self-Test) module 802 provides service to log a POST error, read POST errors and clear the error log.

Event Logger Module

The Event Logger module 804 provides services to log an event; read the event log; erase the event log; lock and unlock the event log; and write the event log to FLASH memory 804A and/or RAM memory 804B.

Non-Volatile Storage Module

The Non-volatile Storage module 806 provides services to read and write to non-volatile storage, as well as restore factory defaults in the event of a read error. These services are performed on the FLASH memory 806A and are used in configuration of the portable vital signs measurement instrument.

Utilities Module

The Utilities module 808 provides a basic set of utility services such as byte swapping of 16-bit and 32-bit variables. For example, the H8 processor is a big-endian machine (first byte written is the byte carrying the most significant data, and the second byte written carries the less significant data), while most PC hosts are little-endian; in order for a big-endian machine and a little-endian machine to access data, the data needs to be reoriented for at least one of the two machines.

Flash Module

The Flash module 810 provides a basic set of services for programming the FLASH memory device 810A.

Version Info Module

The Version Info module 812 provides a set of functions used to access device specific information, including the device software version and signature.

FPROM Module

The FPROM module 814 is responsible for reprogramming the FLASH memory 814A. The FPROM module 814 provides an alternate method of programming a FLASH memory 814A which has already been programmed via the normal masked ROM bootloader. The FPROM module 814 can also program RAM memory 814B.

Operation of the System

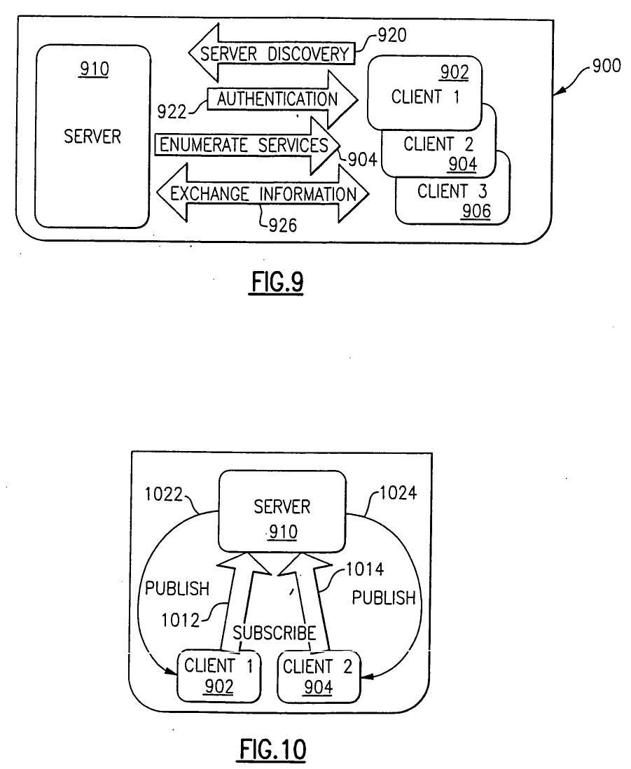

FIG. 9 is a schematic diagram 900 showing an embodiment of the flow of communications between one or more portable vital signs measurement instruments 902, 904, 906 and a server 910. In FIG. 9, the server 910 is an information server that is operational and that has at least one communication access point that operates according to 802.11b wireless interface protocols. In some settings, such as a hospital, there may be a plurality of 802.11b wireless interface access points connected to the server 910. A portable vital signs measurement instrument 902 initiates a communication session by attempting to discover a server access point in its vicinity, and thereby initiate a communication session with the server 910. This initial attempt is indicated by arrow 920. In the initial attempt to discover a server 910, the portable vital signs measurement instrument 902 transmits a message containing a payload that is understood to be a request to open a session. The server 910 responds to a properly formatted initial message by sending an authorization as the payload of the reply message indicated by arrow 922. The authorization in one embodiment is an authentication message encrypted using a “public key encryption” system, for which the portable vital signs measurement instrument 902 is provided a decryption algorithm. Each facility can arrange its own encryption and decryption method, for example using at least one 128-bit key that is provided to all portable vital signs measurement instruments 902, 904, 906 and all servers 910 of the facility. In addition to the encryption of communications, there is a provision for identifying the authorization type or level of any individual who uses a portable vital signs measurement instrument 902, to assure that the requirements of HIPPA are fulfilled. Once a specific portable vital signs measurement instrument 902 has been provided an authorization by the server 910, the server 910 sends a message 924 that contains as its payload information enumerating the services that the portable vital signs measurement instrument 902 can request from the server. Having successfully establish bi-directional communications with a sever 910, the portable vital signs measurement instrument 902 communicates information to, and receives information from, the server 910. The term information is to be construed broadly, and can include any of data, commands, computer programs or files, and signals related to the good order of the communications, such as signals requesting that the communication pause or resume, that a message or a portion thereof be repeated, that a time signal be provided, or other signals that may be needed to assure proper operation of the system. As indicated in FIG. 9, in some embodiments a plurality of portable vital signs measurement instruments 902, 904, 906 can be in communication with the server 910 simultaneously. This means that, in intervals of time perceived by humans as substantially instantaneously, any of portable vital signs measurement instruments 902, 904 and 906 can send or receive information even though another of portable vital signs measurement instruments 902, 904 and 906 is also in communication with the server 910.

In operation, the portable vital signs measurement instruments 902, can send information relating to one or more patient encounters, including information identifying the patient, and information relating to the measurements performed and their outcomes. The server 910 can acknowledge the information. When the portable vital signs measurement instruments 902 receives an acknowledgement that the information it sent has been received and recorded by the server 910, the portable vital signs measurement instruments 902 can delete the locally stored information and reclaim the memory space so free for use in another patient encounter.

FIG. 10 is a diagram showing an embodiment of a subscribe and publish process between a plurality of portable vital signs measurement instruments 902, 904 and a server 910. As indicated in FIG. 10, one or more portable vital signs measurement instruments 902, 904 can subscribe to a service offered by a server 910. Subscribing denotes making use of a particular service that the server offers (for example, supplying a list of patient identification information for patients on a floor), and a subscription can be maintained as long as the client portable vital signs measurement instrument 902 and server 910 are in communication over a valid connection channel, and is indicated by arrows 1012 and 1014. The server 910 “publishes” to the portable vital signs measurement instruments 902, 904, as indicated by arrows 1022, 1024, which involves transmitting to the portable vital signs measurement instruments 902, 904 updates of information, programs, user interface software, and other material that is useful for he operation of the portable vital signs measurement instruments 902, 904 or for the convenience of the users thereof. In some embodiments, a definition language for describing information or services that are made available, such as a current patient context, or a list of patients, doctors, and/or staff, can be provided using a convenient programming language.

Power/Recharging Requirements

The device is powered by a rechargeable battery that is user replaceable. In one embodiment, the battery has a minimum of 100 typical case readings per charge, per fully loaded unit; a minimum of 60 worse case readings per charge, per fully loaded unit; a maximum battery recharge time of 12 hours; a visual battery charge level indicator, a visual charge indicator, a visual power indicator and a warning of battery failure prior to automatic shutoff.

The transformer is certified to meet all applicable safety standards for operation in a patient area in a hospital. Appropriate charging cables are provided. The location of the charging contacts on the device permit any of desktop, wall mount, and mobile stand configurations of operation. There is an optional means of securing the power cable to the transformer so the power cord and transformer appears to be a single piece.

Data Storage Requirements

The portable vital signs measurement instrument stores as many as 50 patient vital signs cycle records. A cycle record optionally contains all the measured parameter readings, manual data entry (e.g., respirations), time stamp information, clinician ID, and patient ID for a single patient encounter. The patient records are stored through power cycles (e.g., during such time that the unit is being recharged), for example in non-volatile memory.

Communications

The device includes a WiFi wireless radio (either internally or as an external peripheral) with antennae, and is 802.11 B compliant. Typical range is 80 feet in an enclosed environment (˜4 walls), or 200 feet in an open space with line of sight. The throughput is limited to a maximum of 700 kbps. Device discovery occurs within 30 seconds. USB 1.1 Slave communications and two RS232 connectors are provided.

Computer Interface

The device is equipped with an accessible interface port to facilitate computer-controlled diagnostics, calibration, factory programming, and end-user interfacing. This port may be the same as that utilized for user options, such as connecting to a computer. In one embodiment, the interface ports are capable of transmitting at 9600 baud using 8 data bits and 1 stop bit, no parity bit, and the transmit and receive data lines are protected against ESD and over voltage.

Safety Testing

The portable vital signs measurement instrument meets all international safety standards for use in a medical environment, including UL 60601-1 (USA), EN60601-1, +A 1, +A2, IEC 60601-1-2, IEC60601-1-4 (Europe, Asia), CSA 22.2#601-1 (Canada), and 3200 Appendix Z (Australia).

Maximum Cuff Pressure Detection

The portable vital signs measurement instrument provides a limit of the maximum cuff pressure so as to never exceed 300 mmHg. Device readings between 20 and 300 mmHg “shall not differ from the pressure indicated by a reference standard by more than +/−3 mmHg of the reading” in compliance with CEN 1060-3.

Residual Pressure Detection

The device incorporates a residual pressure detection module to ensure that cuff pressure is not maintained above 10 mmHg for longer than 5 minutes, or above 15 mmHg for 3 minutes.

Cuff Deflation

An easily accessible and clearly labeled cuff deflation module allows the user to deflate the cuff manually. The cuff deflation module is capable of reducing the pressure in a 500 ml cavity from 260 mmHg to 15 mmHg in less than 10 seconds.

Audible Enunciator

The device notifies the user when it has completed a measurement of any parameter with an audible signal.

Limits and Tolerances

Measurement Ranges:

The device maintains the following accuracy over the above outlined measurement ranges and over the operating environment limits specified.

Blood Pressure Tolerance

The device meets the accuracy specifications outlined by AAMI. AAMI accuracy requirement is confirmed by clinical validation via the AAMI clinical validation protocol. The device allows measurements on pediatric patients; however, the device is not designed to be used on neonates. The device supports a small child cuff with the minimum range of 12.4 cm. The device is used on children 29 days old or older. The device is capable of obtaining accurate blood pressure in spite of slight arm movements (equivalent to or better than CVSM motion tolerance). The unit gives a calculated MAP that is equal to ⅓ (sys-dia)+dia.

Pulse Rate Is measured with a tolerance within 5% of the average actual heart rate between the systolic and diastolic pressures, if measured from BP and not SpO₂. The heart rate accuracy measured using a SpO₂ determination is 3 bpm.

Temperature is measured with a precision of 0.2° F. of the actual patient temperature.

SpO₂—Masimo or Nellcor

SpO₂ readings in the range 70-99% are accurate to within 3%.

Toxicity and Biocompatibility

All patient contact material that is incorporated into the portable vital signs measurement instrument is reviewed for biocompatibility. All biocompatibility assessments is carried out per ISO 10993-1 and documented in the DHF of the portable vital signs measurement instrument.

Mobile Stand

The mobile stand conforms to the industrial design of the portable vital signs monitoring instrument and meets all agency/regulatory requirements for cleaning, tilt, etc. In one embodiment, a 5-wheeled base is offered to meet international requirements. An attached basket provides storage for accessories (e.g., cuff assemblies, SpO₂ accessories and temperature accessories).

Connected Weight Scale

In one embodiment, the weight scale is a stand-alone that is connected to by RS232 cable. In some embodiments, the scale has a weight range of 0-600 lb digital, and can display weight units as either kg or lbs. In some embodiments, the weight display provides a reading in real time, and is stable within 5 seconds. The weight has an accuracy of +/−0.2 lbs over the entire range. Preferably, the unit has dimensions that do not exceed 15″×12″×2″ and a weight of 20 lbs.

Dual Lumen Cuff

Only one Adult bladderless cuff is provided with the portable vital signs monitoring instrument for the US. Units for EMEA is shipped with three cuffs (small adult, adult, and large adult). Units for Asia shall get 2 cuffs (small adult and adult). End-users may order other cuff sizes separately. This cuff conforms to the AAMI sizing and marking requirements.

The unit uses a “linear inflation” system. The unit inflates to the appropriate smart inflation pressure and re-inflates as necessary up to a maximum of 280 mmHg. The device leak rate does not exceed 2 mmHg in 10 seconds with a 200 cc volume across the whole pressure range.

If an accurate systolic pressure cannot be determined, the device may step deflate the cuff as necessary. In general, no more than two re-inflations occur. A visual indicator of the step deflation mode is activated. In general, a standard re-inflation does not occur after attempting to measure a BP for 120 seconds. The unit dumps residual pressure after the diastolic pressure is determined. The minimum inflation time is 10 seconds. The maximum time required to determine a subject's BP is less than or equal to 45 seconds.

Blood Pressure Tubing

In some embodiments, the tubing is able to extend 5 ft and lends itself to easy storage with the unit. In some embodiments, the tubing is dual lumen and the tubing is latex free.

Machine-readable storage media that can be used in the invention include electronic, magnetic and/or optical storage media, such as magnetic floppy disks and hard disks, a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and such machine-readable symbols as one and two dimensional bar codes.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

While the present invention has been explained with reference to the structure disclosed herein, it is not confined to the details set forth and this invention is intended to cover any modifications and changes as may come within the scope of the following claims.

What is claimed is:

1. A portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device.

2. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication intended to discover the presence of said remote wireless communications device, and a second communication for transmitting data, wherein said second communication is a secure communication;
whereby said at least one vital sign of the patient can be monitored and said signal representing said at least one vital sign can be provided wirelessly to said remote wireless communication device.

3. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data, wherein said second communication is a secure communication;
whereby said at least one vital sign of the patient can be monitored and said signal representing said at least one vital sign can be provided wirelessly to said remote wireless communication device.

4. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data, wherein said second communication is a selected one of an encrypted communication and a communication transmitted by a secure channel;
whereby said at least one vital sign of the patient can be monitored and said signal representing said at least one vital sign can be provided wirelessly to said remote wireless communication device.

5. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data, wherein said second communication is a communication controlled as to access according to HIPPA regulations;
whereby said at least one vital sign of the patient can be monitored and said signal representing said at least one vital sign can be provided wirelessly to said remote wireless communication device.

6. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a display.

7. The portable vital signs measurement module of claim 6, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a display, wherein said display comprises an LCD display.

8. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a printer.

9. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a microprocessor and a memory.

10. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a control configured to be operable by an operator of said portable vital signs measurement module.

11. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
wherein said at least one vital sign is a selected one of a non-invasive blood pressure, a pulse rate, a temperature, a physiological level of a chemical substance, a respiration rate, and a waveform indicative of a vital sign.

12. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a transducer configured to measure said at least one vital sign.

13. The portable vital signs measurement module of claim 12, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a transducer configured to measure said at least one vital sign;
wherein said transducer configured to measure said at least one vital sign is demountably attached to said portable measurement module.

14. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
whereby said at least one vital sign of the patient can be monitored and said signal representing said at least one vital sign can be provided wirelessly to said remote wireless communication device; and
further comprising a stand for supporting said portable vital signs measurement module.

15. A portable vital signs measurement system, comprising:
a portable measurement module configured to measure at least one vital sign of a patient, and to produce a signal representative of said at least one vital sign;
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device.

16. The portable vital signs measurement system of claim 15, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a display.

17. The portable vital signs measurement system of claim 16, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a display, wherein said display comprises an LCD display.

18. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a printer.

19. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a microprocessor and a memory.

20. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a control configured to be operable by an operator of said portable vital signs measurement system.

21. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
wherein said at least one vital sign is a selected one of a non-invasive blood pressure, a pulse rate, a temperature, a physiological level of a chemical substance, a respiration rate, and a waveform indicative of a vital sign.

22. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a transducer configured to measure said at least one vital sign.

23. The portable vital signs measurement system of claim 22, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a transducer configured to measure said at least one vital sign, wherein said transducer configured to measure said at least one vital sign is demountably attached to said portable measurement system.

24. The portable vital signs measurement system of claim 15, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data; and
said remote wireless communication device in communication with a computer-based data management system;
whereby said at least one vital sign of the patient can be monitored and provided to said computer-based data management system by way of said remote wireless communication device; and
further comprising a stand for supporting said portable vital signs measurement system.

25. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA.

26. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information privacy requirements compatible with HIPPA comprise using information read by said reader from said machine-readable repository of information to identify at least one of said patient and a person operating said portable vital signs measurement module.

27. The portable vital signs measurement module of claim 26, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information privacy requirements compatible with HIPPA comprise using information read by said reader from said machine-readable repository of information to identify at least one of said patient and a person operating said portable vital signs measurement module; and
wherein said information identifying at least one of said patient and a person operating said portable vital signs measurement module is encoded into said communication.

28. The portable vital signs measurement module of claim 26, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information privacy requirements compatible with HIPPA comprise using information read by said reader from said machine-readable repository of information to identify at least one of said patient and a person operating said portable vital signs measurement module; and
wherein said information identifying at least one of said patient and a person operating said portable vital signs measurement module is used to control access to information relating to said patient.

29. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information security requirements compatible with HIPPA comprise using a secure communication.

30. The portable vital signs measurement module of claim 29, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information security requirements compatible with HIPPA comprise using a secure communication;
wherein said secure communication comprises a communication sent by way of a secure communication channel.

31. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a reader for reading a machine-readable repository of information;
whereby said at least one vital sign of the patient can be monitored and said signal representing said at least one vital sign can be provided wirelessly to said remote wireless communication device in accordance with information privacy and security requirements compatible with HIPPA;
wherein information security requirements compatible with HIPPA comprise using a secure communication;
wherein said secure communication comprises an encrypted communication.

32. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication and a second communication for transmitting data;
and further comprising a location module that provides the ability to discover a location of a particular instrument;
whereby said at least one vital sign of the patient can be monitored and said signal representing said at least one vital sign can be provided wirelessly to said remote wireless communication device, and said vital signs monitor can be located spatially within a facility.

33. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication and a second communication for transmitting data;
and further comprising a history tracking module for tracking the history of usage of a particular vital signs measurement module;
whereby said at least one vital sign of the patient can be monitored and said signal representing said at least one vital sign can be provided wirelessly to said remote wireless communication device, and a usage profile of said vital signs measurement module can be determined.

34. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication and a second communication for transmitting data;
and further comprising a base unit configured to communicate with wireless sensors that have limited transmission distances and are coded to communicate to said base unit only;
whereby said at least one vital sign of the patient can be monitored and said signal representing said at least one vital sign can be provided wirelessly to said remote wireless communication device, and said vital sign measurement module can provide network connectivity to said wireless sensors coded to communicate to said vital signs measurement module.

35. The portable vital signs measurement module of claim 1, comprising a portable measurement module configured to measure at least one vital sign of a patient, and to produce a signal representative of said at least one vital sign; and
a wireless communication interface module configured to receive said signal representing said at least one vital sign and configured to communicate with a remote wireless communication device, said wireless communication interface module configured to initiate said communication with said remote wireless communications device using a first communication, and a second communication for transmitting data;
and further comprising a central access point through which data is communicated;
whereby said at least one vital sign of the patient can be monitored and said signal representing said at least one vital sign can be provided wirelessly to said remote wireless communication device, and said vital sign measurement module can provide data communication between a network and other instruments.

36. A method of measuring a vital sign of a patient, the method comprising the steps of:
providing a portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device;
measuring said at least one vital sign of the patient; and
transmitting wirelessly said signal to said remote wireless communication device.

37. The method of measuring a vital sign of a patient of claim 36, the method comprising the steps of:
providing a portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device;
measuring said at least one vital sign of the patient; and
transmitting wirelessly said signal to said remote wireless communication device;
wherein the step of transmitting wirelessly said signal comprises transmitting said signal securely.

38. The method of measuring a vital sign of a patient of claim 36, the method comprising the steps of:
providing a portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device;
measuring said at least one vital sign of the patient; and
transmitting wirelessly said signal to said remote wireless communication device;
wherein the step of transmitting wirelessly said signal comprises transmitting said signal securely, and
wherein said signal that is transmitted securely comprises a communication controlled as to access according to HIPPA regulations.

39. The method of measuring a vital sign of a patient of claim 36, the method comprising the steps of:
providing a portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device;
measuring said at least one vital sign of the patient; and
transmitting wirelessly said signal to said remote wireless communication device;
wherein the step of transmitting wirelessly said signal comprises transmitting said signal securely, and
wherein said signal that is transmitted securely is a selected one of an encrypted communication and a communication transmitted by a secure channel.

40. The method of measuring a vital sign of a patient of claim 36, the method comprising the steps of:
providing a portable vital signs measurement module, comprising:
a portable measurement module configured to measure at least one vital sign of a patient, and to produce a signal representative of said at least one vital sign; and
a wireless communication interface module configured to receive said signal representing said at least one vital sign and configured to communicate with a remote wireless communication device;
measuring said at least one vital sign of the patient; and
transmitting wirelessly said signal to said remote wireless communication device;
the method further comprising the step of communicating said signal representative of said at least one vital sign from said remote wireless communication device to a computer-based data management system in communication therewith.
